(19) United States
(12) Patent Application Publication
(10) Pub. No.: US 2020/0143636 A1
(43) Pub. Date: May 7, 2020

(54) SYSTEMS FOR HYBRID BONUS INTERACTIVE WAGERING

(71) Applicant: Gamblit Gaming, LLC, Glendale, CA (US)

(72) Inventors: Bryce Cire, Pasadena, CA (US); Eric Meyerhofer, Pasadena, CA (US)

(21) Appl. No.: 16/593,863

(22) Filed: Oct. 4, 2019

Related U.S. Application Data
(60) Provisional application No. 62/827,828, filed on Apr. 1, 2019.
(60) Provisional application No. 62/742,425, filed on Oct. 7, 2018.
(60) Provisional application No. 62/741,486, filed on Oct. 4, 2018.

(51) Int. Cl. G07F 17/32; G07F 17/34

(52) U.S. Cl. CPC G07F 17/3262; G07F 17/34

(57) ABSTRACT

An electronic gaming machine for a hybrid bonus interactive wagering process. The electronic gaming machine includes an interactive controller and a processor controller. The interactive controller generates an interactive user interface including interactive elements, detects player interactions of a player with the interactive user interface to determine achievement of a base objective, determines an interactive intermediate state of the hybrid bonus interactive wagering process based on the achievement of the base objective, communicates the interactive intermediate state to the process controller, receives an additional objective from the process controller, and updates the interactive user interface based on the additional objective. The process controller receives the interactive intermediate state from the interactive controller, generates a chance-based outcome using the random number generator in response to receiving the interactive intermediate state, and in a case the chance-based outcome is not a win for the player, generates the additional objective.

### CROSS REFERENCE TO RELATED APPLICATIONS

This application claims the benefit of U.S. Provisional Application No. 62/741,486, filed Oct. 4, 2018, U.S. Provisional Application No. 62/742,425, filed Oct. 7, 2018, and U.S. Provisional Application No. 62/827,828, filed Apr. 1, 2018, the contents of each of which are incorporated by reference herein.

### FIELD OF THE INVENTION

Embodiments of the invention are generally related to systems for data processing. More particularly, embodiments of the invention relate to systems for hybrid bonus interactive wagering processing.

### BACKGROUND

The gambling industry has developed simple gambling games that are implementable on simple gaming devices and systems. For example, U.S. Pat. No. 6,905,405 to McClintic describes a simple gaming device provided with a central processor (CPU) operably coupled to controlling software memory, which includes assigned memory locations storing game software and system software. Such controlling software memory dictates when selected graphics or messages are displayed to a player, as well as when play sequences begin and end and management of wager input and award output. The CPU is also operably coupled to a second memory, which is employed to store data indicative of game statistics, number of plays, number of wins, etc. Controlling software memory, a second memory, or other, ancillary memory store data indicative of winning results, such as data representative of one or more symbol combinations, including winning combinations. Second memory may also be used, for example, to store a bit map of the symbol pattern depicted as a matrix display on video monitor. In operation of the gaming device the CPU carries out instructions of the system software to implement an initial display pattern on the video monitor and to enable the input devices. After a wager is received a player activates an initiator element such as a handle, a physical button or a touch screen to initiate a play sequence. At this point, the game software, in conjunction with a random number generator, generates a random symbol configuration at for a random final outcome comprised of a pattern of symbols for depiction on video monitor. System software then animates the video monitor by simulating the movement of visible representations of symbol carriers including symbols thereon so that the player perceives symbol carrier rotational “movement” of each symbol carrier as well as, optionally, rotational movement of the entire group of symbol carriers about a common axis. Once the visible representations of the symbol carriers have stopped, all of the generated, displayed symbols comprising a winning combination or combinations in the matrix display are identified or flagged. The displayed results (pattern of symbols depicted on the video monitor, which may include symbols received from a remote location, is compared with data stored in game software representing winning combinations to determine if any displayed combination on an active pay line is a winning combination. Any identified winning combination or combinations of symbols are then associated with winnings to be distributed to the player according to a paytable of the game software associated with the various possible winning combinations. The various pay line configurations and required combinations of the various indicia for a winning combination within each pay line reside within the game software and are retrieved for comparison to the randomly generated pattern of indicia depicted on the video monitor.

Such a simple gaming device is capable of implementing a mechanical 3-reel slot machine having 22 possible positions or symbols on each reel. In such a simple game, there are 22\hat{ }3, or 10,648, possible pays based on the combinations of the reel positions. Each time the slot machine is played, a single pay is determined from randomly spinning the mechanical reels. If a 3-reel slot machine is implemented on a simple gaming device having virtual video reels, each possible pay is explicitly enumerated in a table that is used to determine a pay as well as determine an animation sequence for the video virtual reels that corresponds to the pay. Such a table will have at least 10,648 locations, one position for each possible combination of the 3 reels, with each location representing a pay and a representation of the stopped position of the 3 reels. If digital storage of each pay requires 8 bytes of storage, the table can be stored in approximately 83 kilobytes of digital memory (8 bytes of data for each pay and reel animation identifier×10,648 possible pays/1024 Bytes per kilobyte). In operation, a single random number is determined, and that random number is used as an index into the table to select a pay and reel animation identifier from the 10,648 possible pays and reel animations. Accordingly, approximately 83 kilobytes of memory is needed to store all of the enumerated pay and reel animations of a simple slot machine game having approximately 10 thousand pay and reel animations on a simple gaming device.

Operation of another simple gaming system is described in U.S. Pat. No. 6,409,602 issued to Wiltshire et al. A game program is executed on server/host computer. It is then determined whether an image is to be displayed on a screen of a client/terminal computer. If so, an image is sent from the server/host computer to client/terminal computer. The image may include any type of graphical information including a bitmap, a JPEG file, a TIFF file or even an encoded audio/video stream such as a compressed video MPEG stream. The image is generated by game computer program and passed to server/host interface program. In turn, the image is transferred over communication pathways to client/terminal computer via the network services provided by server operating system. The image is received by a client/terminal program executing on the client/terminal computer via the network services provided by client operating system. The client/terminal program then causes the image to be displayed on a screen of the client/terminal computer. It is then determined whether an input command has been entered by the patron using the client/terminal.

In the simple gaming system, all images of the wagering game are generated on the server/host and then all of the images are transferred to the client/terminal. This limits the complexity of the interactions by the player with a wagering game hosted by the server/host because of the time required to communicate the images between the server/host and as well as network lag in requesting the transfer of the images.

Accordingly, simple gaming devices and systems are not capable of implementing complex hybrid bonus interactive wagering processes. Various aspects and embodiments of the invention meet such a need.

### SUMMARY

Systems and methods in accordance with embodiments of the invention detect and processes interactive stochastic events and system stochastic events in order to implement a hybrid bonus interactive wagering process.

In an embodiment, a hybrid bonus interactive wagering electronic gaming machine includes an interactive controller constructed to receive one or more stochastic elements of a hybrid bonus interactive wagering process from a process controller, generate an interactive user interface using the one or more stochastic elements, detect player interactions of a player with the interactive user interface, determine one or more interactive intermediate states of the hybrid bonus interactive wagering process based on the player interactions and the one or more stochastic elements, and communicate the one or more interactive intermediate states to the process controller. The hybrid bonus interactive wagering electronic gaming machine further includes the process controller operatively connected to the interactive controller, wherein the process controller includes a random number generator, and wherein the process controller is constructed to generate one or more stochastic components using the random number generator, generate the one or more stochastic elements using the one or more stochastic components, determine one or more chance-based intermediate states of the hybrid bonus interactive wagering process, communicate the one or more stochastic elements to the interactive controller, receive the one or more interactive intermediate states from the interactive controller, and determine a wagering outcome for the hybrid bonus interactive wagering process using the intermediate states.

In an embodiment, an electronic gaming machine for performing a hybrid bonus interactive wagering process includes an interactive controller constructed to generate an interactive user interface including interactive elements, detect player interactions of a player with the interactive elements of the interactive user interface to determine achievement of a base objective, determine an interactive intermediate state of the hybrid bonus interactive wagering process based on the achievement of the base objective, communicate the interactive intermediate state to the process controller, receive an additional objective from the process controller, and update the interactive user interface based on the additional objective. The process controller is operatively connected to the interactive controller and includes a random number generator. The process controller is constructed to receive the interactive intermediate state from the interactive controller, generate a chance-based outcome using the random number generator in response to receiving the interactive intermediate state, and in a case the chance-based outcome is not a win for the player, generate the additional objective and communicate the additional objective to the interactive controller.

In another embodiment, the interactive controller and the process controller are constructed from the same device.

In yet another embodiment, the process controller is operatively connected to the interactive controller using a communication link.

In yet another embodiment, electronic gaming machine for performing the hybrid bonus interactive wagering further includes an enclosure constructed to mount a user input device operatively connected to the interactive controller, a user output device operatively connected to the interactive controller, a credit input device operatively connected to the credit processing subcontroller, and a credit output device operatively connected to the credit processing subcontroller. The process controller is further constructed to communicate with the credit input device to receive a credit input, credit a credit meter with credits based on the incoming credit data, and in a case the chance-based outcome is a win for the player, determine a wagering outcome of the hybrid bonus interactive wagering process using the chance-based outcome, update the credit meter based on the wagering outcome, and communicate with the credit output device to generate a credit output based on credits transferred off of the credit meter.

In yet another embodiment, an electronic gaming machine for performing a hybrid bonus interactive wagering process includes a random number generator, at least one processor, and a memory operatively connected to the at least one processor, the memory storing processor executable instructions that when executed by the processor cause the processor to generate an interactive user interface including interactive elements, detect player interactions of a player with the interactive elements of the interactive user interface to determine achievement of a base objective, determine an interactive intermediate state of the hybrid bonus interactive wagering process based on the achievement of the base objective, generate a chance-based outcome using the random number generator in response to determining the interactive intermediate state, and in a case the chance-based outcome is not a win for the player, generate an additional objective and update the interactive user interface based on the additional objective.

In yet another embodiment, an electronic gaming machine for performing the hybrid bonus interactive wagering process further includes an enclosure constructed to mount a user input device operatively connected to the at least one processor, a user output device operatively connected to the at least one processor, a credit input device operatively connected to the at least one processor, and a credit output device operatively connected to the at least one processor. Executable instructions when executed by the at least one processor further cause the at least one processor to communicate with the credit input device to receive a credit input, credit a credit meter with credits based on the incoming credit data, and in a case the chance-based outcome is a win for the player, determine a wagering outcome of the hybrid bonus interactive wagering process using the chance-based outcome, update the credit meter based on the wagering outcome, and communicate with the credit output device to generate a credit output based on credits transferred off of the credit meter.

### BRIEF DESCRIPTION OF THE DRAWINGS

FIG. 1 illustrates a state diagram, a multidimensional process space diagram, and a user interface block diagram of a hybrid bonus interactive wagering system for performing a hybrid bonus interactive wagering process in accordance with various embodiments of the invention.

FIG. 2 is a diagram of a structure of a hybrid bonus interactive wagering system for performing a hybrid bonus interactive wagering process in accordance with various embodiments of the invention.

FIG. 3A is a diagram of an electronic gaming machine configuration of a hybrid bonus interactive wagering system for performing a hybrid bonus interactive wagering process in accordance with various embodiments of the invention.

FIG. 3B is a diagram of a table electronic gaming machine configuration of a hybrid bonus interactive wagering system for performing a hybrid bonus interactive wagering process in accordance with various embodiments of the invention.

FIG. 3C is a diagram of a virtual reality gaming machine configuration of a hybrid bonus interactive wagering system for performing a hybrid bonus interactive wagering process in accordance with various embodiments of the invention.

FIG. 4 is a diagram of distributed hybrid bonus interactive wagering system for performing a hybrid bonus interactive wagering process in accordance with various embodiments of the invention.

FIGS. 5A and 5B are diagrams of a structure of an interactive controller of a hybrid bonus interactive wagering system for performing a hybrid bonus interactive wagering process in accordance with various embodiments of the invention.

FIG. 6 is a diagram of a structure of a process controller of a hybrid bonus interactive wagering system for performing a hybrid bonus interactive wagering process in accordance with various embodiments of the invention.

FIG. 7 is an activity diagram illustrating an algorithm of a hybrid bonus interactive wagering process performed by a hybrid bonus interactive wagering system in accordance with various embodiments of the invention.

FIGS. 8A and 8B are sequence diagrams illustrating algorithms of a hybrid bonus interactive wagering process performed by a hybrid bonus interactive wagering system in accordance with various embodiments of the invention.

FIG. 9A is a block diagram of credit flows within a closed loop hybrid bonus interactive wagering system in accordance with various embodiments of the invention.

FIG. 9B is another block diagram illustrating credit flows within a hybrid bonus interactive wagering system having a closed loop accommodating sub-optimal play in accordance with various embodiments of the invention.

FIG. 10 is a block diagram of credit flows within an open loop hybrid bonus interactive wagering system in accordance with various embodiments of the invention.

FIG. 11 is a block diagram of credit flows within a hybrid bonus interactive wagering system having both open and closed loops in accordance with various embodiments of the invention.

FIG. 12 is a block diagram of credit flows within a hybrid bonus interactive wagering system having both open and closed loops accommodating sub-optimal play in accordance with various embodiments of the invention.

FIG. 13 is another block diagram of credit flows within a hybrid bonus interactive wagering system having both open and closed loops accommodating sub-optimal play in accordance with various embodiments of the invention.

FIG. 14 is a state diagram of a process of a hybrid bonus interactive wagering system in accordance with various embodiments of the invention.

FIGS. 15A to 15D are illustrations of a user interface of a hybrid bonus interactive wagering system in accordance with various embodiments of the invention.

FIG. 16 is a flow chart of a process of a hybrid bonus interactive wagering system in accordance with various embodiments of the invention.

FIG. 17 is a state diagram of another process of a hybrid bonus interactive wagering system in accordance with various embodiments of the invention.

FIG. 18 is an illustration of a user interface of a hybrid bonus interactive wagering system in accordance with various embodiments of the invention.

FIG. 19 is another illustration of a user interface of a hybrid bonus interactive wagering system in accordance with various embodiments of the invention.

FIG. 20 is a state diagram of another process of a process of a hybrid bonus interactive wagering system in accordance with various embodiments of the invention.

FIG. 21 is another illustration of a user interface of a hybrid bonus interactive wagering system in accordance with various embodiments of the invention.

FIGS. 22A and 22B are illustrations of another user interface of a hybrid bonus interactive wagering system in accordance with various embodiments of the invention.

FIGS. 23A and 23B are illustrations of another user interface of a hybrid bonus interactive wagering system in accordance with various embodiments of the invention.

### DETAILED DESCRIPTION

A hybrid bonus interactive wagering session in accordance with various embodiments of the invention includes determining by a hybrid bonus interactive wagering system a wagering outcome for a wager committed by a player during the hybrid bonus interactive wagering session. Hybrid bonus interactive wagering utilizes system generated chance-based components and system detected player interactions with interactive objects of the system to generate a wagering outcome. In some embodiments of hybrid bonus interactive wagering, a wagering outcome includes both a skill-based interactive outcome component and a system generated chance-based outcome component, that is, the overall return to player (RTP) of the system is a combination of players' skill and chance-based outcomes. Through the use of the chance-based outcome component, a minimum (RTP) can be assured that is independent of players' skillful play while a portion of wagered credits are also awarded to the players based on the players' skillful play as determined by a skill metric of the skill-based interactive component. Optimal play occurs when players' skillful play results in players receiving all due skill-based outcomes and thus the actual RTP of the system is equal to the theoretical maximum RTP. Sub-optimal play occurs when players play less skillfully resulting in the players receiving less than all due skill-based outcomes and thus the actual RTP of the system is less than the theoretical maximum RTP.

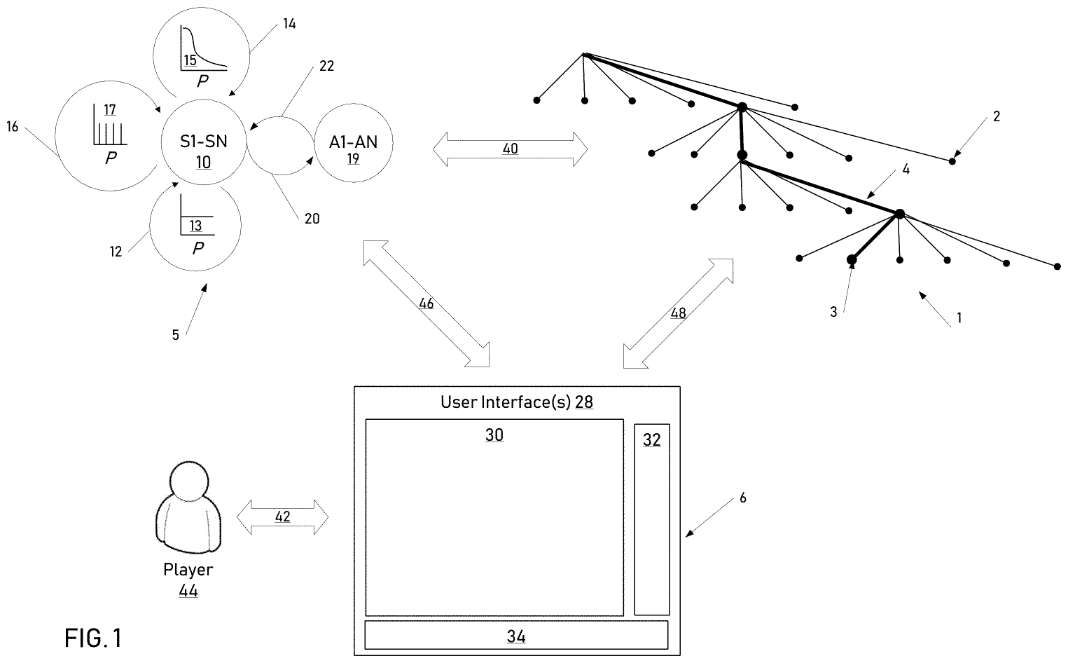

FIG. 1 illustrates a state diagram 5 of a state machine, a multidimensional process space diagram 1, and a user interface block diagram 6 of a hybrid bonus interactive wagering system for performing a hybrid bonus interactive wagering process in accordance with various embodiments of the invention. A multidimensional process space diagram, illustrated herein using a tree diagram 1, illustrates a process space or game space of a hybrid bonus interactive wagering process in accordance with various embodiments of the invention. The process space of a hybrid bonus interactive wagering process can be modeled using a multidimensional process space or manifold where each dimension of the manifold is associated with one or more variables of one or more stochastic events of a hybrid bonus interactive wagering process. A hybrid bonus interactive wagering process has multiple states within the multidimensional process space, herein represented by nodes in the tree diagram. Some of the nodes represent intermediate states, such as node 2, of a hybrid bonus interactive wagering process and some of the nodes, such as node 3, represent award states representing wager outcomes of a hybrid bonus interactive wagering process. A traversal of the multidimensional process space, such as traversal 4, can be used to model an individual wager of the hybrid bonus interactive wagering process.

FIG. 1 also includes a state diagram 5 of a state machine of a hybrid bonus interactive wagering system that performs a hybrid bonus interactive wagering process in accordance with various embodiments of the invention. A traversal 4 of the interactive process space 1 of a hybrid bonus interactive wagering process can be preformed by the state machine 5 having a set of one or more intermediate states, such as intermediate states S1 to state SN 10, and one or more award states, such as award states A1 to state AN 19. A transition between some of the states may occur in response to nondeterministic stochastic events during a hybrid bonus interactive wagering process, such a transition is herein termed a stochastic transition. Different types and different combinations of types of stochastic events cause different types of stochastic transitions between states of a hybrid bonus interactive wagering process.

The set of states of the state machine are encompassed by the process space 1 of a hybrid bonus interactive wagering process and the state machine performs a traversal 4 of the process space 1 during a wager in accordance with a hybrid bonus interactive wagering process as indicated by double headed arrow 40.

In many embodiments, one or more stochastic transitions are made by the hybrid bonus interactive wagering system during a hybrid bonus interactive wagering process as a result of respective one or more stochastic events generated by a hybrid bonus interactive wagering system, such as stochastic transition 12, where the probability that the stochastic event is generated has a probability distribution 13. A stochastic event generated by a hybrid bonus interactive wagering system is herein termed a system stochastic event and a state associated with a system stochastic event is herein termed a system intermediate state.

In some embodiments, one or more stochastic transitions occur based on detection by a hybrid bonus interactive wagering system of a player's interaction with a hybrid bonus interactive wagering process, such as stochastic transition 14. The stochastic transition is based upon detection by a hybrid bonus interactive wagering system of an interaction by a player with an interactive element of the one or more user interfaces 30 of a hybrid bonus interactive wagering system. The probability that a player will interact with the interactive element to effect a particular stochastic transition may be described using a probability distribution 15 for the player interaction. A stochastic event resulting from detection by a hybrid bonus interactive wagering system of a player interaction is herein termed an interactive stochastic event and intermediate state associated with detecting an interactive stochastic event is herein termed an interactive intermediate state.

In various embodiments, a stochastic transition occurs as a result of detecting an interactive stochastic event that is a player's selection made between two or more selectable interactive elements, as exemplified by stochastic transition 16 having a discrete probability distribution 17.

A hybrid bonus interactive wagering process may also include one or more award states, such as award states A1 to AN 19. Each award state represents an award of value awarded to a player. When a hybrid bonus interactive wagering process transitions 20 to an award state an award is awarded to a player by the hybrid bonus interactive wagering system performing the hybrid bonus interactive wagering process. In some embodiments, a hybrid bonus interactive wagering process transitions 22 from an award state back to an intermediate state for further interactive wager processing.

FIG. 1 also includes a block diagram 6 illustrating a user interface and display of a hybrid bonus interactive wagering system in accordance with various embodiments of the invention. A hybrid bonus interactive wagering system includes one or more user interfaces 28 that are used to display to a player 44 an interactive presentation generated by a hybrid bonus interactive wagering system based on the state machine 5 (as indicated by double arrow 46) and based on the traversal 4 of the process space 1 (as indicated by double arrow 48) of a hybrid bonus interactive wagering process performed by a hybrid bonus interactive wagering system. The one or more user interfaces 28 are also used by a hybrid bonus interactive wagering system to detect player interactions 42 with the interactive presentation.

The one or more user interfaces 28 include one or more interactive user interface portions 30 having a display used by a hybrid bonus interactive wagering system to display to a player interactive objects that the player interacts with and to detect user interactions with the interactive objects during a hybrid bonus interactive wagering process. In many embodiments, the one or more user interfaces also include one or more wagering user interface portions 34 having a display used by a hybrid bonus interactive wagering system to display to a player a state of a hybrid bonus interactive wagering process and detect player interactions with the wagering user interface. In many embodiments, the one or more wagering user interfaces also include one or more wager process user interface portions 32 having a display used by a hybrid bonus interactive wagering system to display to a player a stochastic element generation process such as, but not limited to, a generation process of one or more chance-based outcomes.

By utilizing the one or more user interfaces 28 and associated displays, a hybrid bonus interactive wagering system can integrate interactive stochastic events, system stochastic events, intermediate states, and award states of a process space of a hybrid bonus interactive wagering process into a user interface and communicate a state of a hybrid bonus interactive wagering process to the player all the while executing a hybrid bonus interactive wagering process seamlessly from the player's perspective.

Some embodiments of hybrid bonus interactive wagering processes have sets of intermediate states and award states whose sizes are many orders of magnitude larger than a set of pays of a simple slot machine game. In an example embodiment, a hybrid bonus interactive wagering process includes a display where selectable chance-based outcomes are displayed to a player as a set of possible award states. The display includes 9 locations with each location having twenty-two possible chance-based outcomes. Such a hybrid bonus interactive wagering process display has 1,207,269,217,792, or over 1.2 trillion, possible award states. If 8 bytes of digital memory are used to store each award state, then a complete enumeration of all of award states, as required using simple gaming devices, would require 9.6 terabytes of memory storage. However, utilization a hybrid bonus interactive wagering system and hybrid bonus interactive wagering processes as described herein reduces the storage memory requirement of a hybrid bonus interactive wagering process. This reduction in memory requirement reduces the amount of physical and/or virtual memory needed to implement a hybrid bonus interactive wagering process, and also may reduce an amount of time needed to generate a hybrid bonus interactive wagering process display.

In another example embodiment, a hybrid bonus interactive wagering process has a process space with 17 dimensions and approximately 1,576,418,005,371,090,000,000, or over 1.5 sextillion possible intermediate states and award states. Enumeration and storage of the set of states for implementation of such a hybrid bonus interactive wagering process on a simple electronic gaming machine would require over 12.6 zettabytes of addressable memory storage. Furthermore, if it took only 1 billionth of a second to enumerate each state, it would take almost 50,000 years to enumerate the complete set of states. Accordingly, some hybrid bonus interactive wagering processes are simply not implementable using simple electronic gaming machines. However, hybrid bonus interactive wagering processes having large sets of states may be implemented on various embodiments of a hybrid bonus interactive wagering system.

In some embodiments, the hybrid bonus interactive wagering system's user interfaces and associated displays allow transparent coupling of an interactive game to wagering propositions, providing a seamless perspective to the player that they are playing an interactive game such as, but not limited to, a video game. In accordance with some embodiments, a hybrid bonus interactive wagering system can be used to enable a wide range of interactive video games including but not limited to popular titles from arcade and home video games.

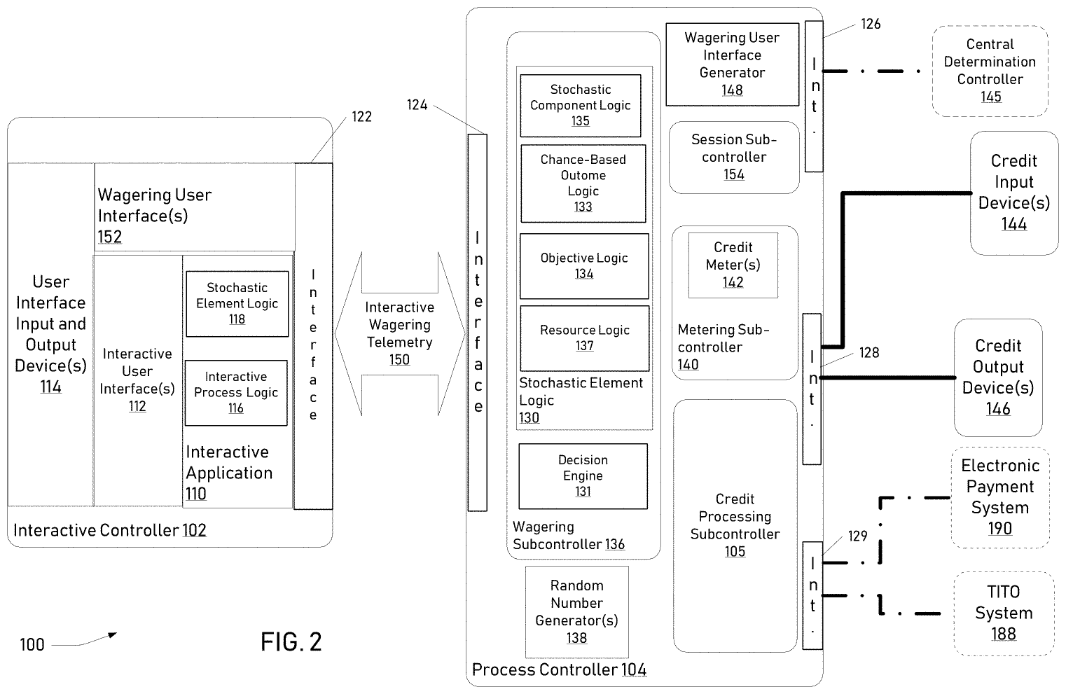

FIG. 2 is a diagram of an architecture of a hybrid bonus interactive wagering system in accordance with various embodiments of the invention. The hybrid bonus interactive wagering system is designed to implement a hybrid bonus interactive wagering process through the generation, detection, and processing of stochastic events. The hybrid bonus interactive wagering system 100 includes an interactive controller 102 and a process controller 104. The process controller 104 is also operatively connected to, and communicates with, various credit input and credit output devices and/or systems, such as one or more credit input devices 144, one or more credit output devices 146, a electronic payment system 190 and/or a ticket-in-ticket-out system 188, using a credit processing subcontroller 105.

In various embodiments, the interactive controller 102 detects player interactions with a hybrid bonus interactive wagering process implemented by a hybrid bonus interactive wagering system. The interactive controller 102 executes an interactive application 110 and provides one or more user interface user input and output devices 114 so that one or more players can interact with the interactive application 110. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, ear buds, and the like; visual output devices such as lights, video displays and the like; and tactile devices such as rumble pads, hepatic touch screens, buttons, keys and the like. The interactive controller 102 provides for player interactions with the interactive application 110 by executing the interactive application 110 that generates an interactive user interface 112 that utilizes the user input devices to detect player interactions with interactive elements of the interactive application 110 of the interactive controller 102 and generates an interactive user interface that is presented to the player utilizing the user output devices.

In some embodiments, one or more components of an interactive controller are housed in an enclosure such as a housing, cabinet, casing or the like. The enclosure further includes one or more player accessible openings or surfaces constructed to mount the user input devices and/or the user output devices.

The interactive controller 102 is operatively connected to, and communicates with, the process controller 104. The interactive controller 102 receives application resource data, as part of hybrid bonus interactive wagering telemetry data 150, including but not limited to, stochastic element data from the process controller 104.

In some embodiments, during execution of the interactive application 110 by the interactive controller 102, the interactive controller 102 communicates, as part of wagering telemetry data 150, detected player interactions with one or more interactive elements of the interactive user interfaces 112 of the interactive application, to the process controller 104. The hybrid bonus interactive wagering telemetry data 150 may include, but is not limited to, interactive application variables that indicate the state of the interactive application 110, interactive controller data indicating a status of the interactive controller 102, detected player actions and interactions between one or more players and the interactive application 110, one or more interactive intermediate states of and/or one or more award states based on the detected player interactions with interactive elements of the interactive application 110, and utilization of interactive elements of the interactive application 110 by one or more players.

In many embodiments, the interactive application 110 includes stochastic element logic 118 utilized by the interactive application to generate one or more in-application resources and/or interactive elements in accordance with stochastic element data received from the process controller 104 included in the wagering telemetry data 150.

In some embodiments, the interactive application 110 determines one or more award states based on detection of the interactions of the one or more players with interactive elements of the interactive application and communicates data of the determined award states to the process controller 104 as part of the hybrid bonus interactive wagering telemetry 150. In some embodiments, the interactive application 110 also communicates as part of the hybrid bonus interactive wagering telemetry data 150, data encoding the one or more players' interactions with the interactive application 110 and stochastic event data of stochastic events detected by the interactive application 110.

In some embodiments, the interactive application 110 is a skill-based interactive application, such as but not limited to a skill-based game. In embodiments, during execution of the skill-based interactive application 110 by the interactive controller 102, the interactive controller 102 detects the players' skillful interaction with interactive elements of the interactive application 110 during the players' skillful interaction with the skill-based interactive application 110 to achieve an objective of the skill-based game. The process controller 104 communicates with the interactive controller 102 in order to allow the coupling of the skill-based interactive application 110 to stochastic elements generated in accordance with a hybrid bonus interactive wagering process implemented by the process controller 104 and/or the interactive controller 102.

In various embodiments, a hybrid bonus interactive wagering system can include an interactive application 110 that provides for player versus player (PvP) competitive play between a single player and a computing device, between two or more players against one another, or multiple players playing against a computing device and/or each other. In embodiments, stochastic elements of a hybrid bonus interactive wagering process may be interjected into the competitive play to either enhance or disrupt one or more players' competitive play of the interactive application 110.

In some embodiments, the stochastic element logic 118 is communicated to the interactive controller 102 by the process controller 104 as part of the wagering telemetry data 150.

In some embodiments, the interactive controller 102 includes one or more sensors (not shown) that sense various aspects of the physical environment of the interactive controller 102. Examples of sensors include, but are not limited to: global positioning sensors (GPSs) for sensing communications from a GPS system to detect a position or location of the interactive controller; temperature sensors; accelerometers; pressure sensors; and the like. Sensor telemetry data detected from the one or more sensors are communicated by the interactive controller to the process controller 104 as part of the hybrid bonus interactive wagering telemetry data 150. The process controller 104 receives the sensor telemetry data and uses the sensor telemetry data along with stochastic element logic 118 to generate stochastic elements of a hybrid bonus interactive wagering process as described herein.

In many embodiments, the interactive controller 102 includes one or more wagering user interfaces 152 used to display wagering data, via one or more of the user interface input and output devices 114, to one or more players. The one or more wagering user interfaces include a display to one or more players of various wagering data that may include, but is not limited to, an amount of credits committed to a wager, a denomination of a wager, an amount of credits won as the result of a successful wager, and an amount of credits in a credit meter associated with the one or more players.

In various embodiments, an application control interface 122 resident in the interactive controller 102 provides an interface between the interactive controller 102 and the process controller 104 via interface 124.

In some embodiments, interfaces 122 and 124 implement an interactive controller to process controller communication protocol employing an interprocess communication protocol so that an interactive controller and a process controller may be implemented on the same device. During a hybrid bonus interactive wagering process, the application control interface 122 provides application programming interfaces (APIs) that are used by an interactive application of the interactive controller to communicate outgoing data and receive incoming data by passing parameter data to another process or application.

In some embodiments, interfaces 122 and 124 implement an interactive controller to process controller communication protocol employing an interdevice communication protocol so that an interactive controller and a process controller may be implemented on different devices. The interdevice protocol may utilize a wired communication bus or wireless network as a physical layer.

In various embodiments, interfaces 122 and 124 implement an interactive controller to process controller communication protocol employing a networking protocol so that an interactive controller and a process controller may be implemented on different devices connected by a network. The networking protocol may utilize a wired communication bus or wireless network as a physical layer. In many embodiments, the network includes a cellular telephone network or the like and the interactive controller is a mobile device such as a smartphone, tablet computer or other device capable of using the telephone network. During operation, the application control interface 122 communicates outgoing data to an external device by encoding the data into a signal and transmitting the signal to an external device. The application control interface receives incoming data from an external device by receiving a signal transmitted by the external device and decoding the signal to obtain the incoming data.

In several embodiments, interfaces 122 and 124 implement an encrypted communication protocol so that data communicated between the controllers may be encrypted to increase security of the hybrid bonus interactive wagering system.

In various embodiments, the process controller 104 includes a wagering subcontroller 136 that uses interactive stochastic element logic 118, and one or more random number generators 138 to initiate random number generation by the random number generators and generate stochastic elements used by the hybrid bonus interactive wagering system to perform a hybrid bonus interactive wagering process.

In some embodiments, stochastic elements include, but are not limited to, stochastic components that are data values generated using one or more outputs of one or more random number generators 138 in accordance with stochastic component logic 135. In various embodiments, the stochastic components may be used in further processing by either the interactive controller 102 or the process controller 104 to generate one or more additional stochastic elements.

In various embodiments, stochastic elements include, but are not limited to, chance-based outcomes that are an amount of credits or other items having value as described herein. The chance-based outcomes are generated in accordance with chance-based outcome logic 133 and one or more outputs from the one or more random number generators 138. In an example embodiment, the chance-based outcomes are stored in a lookup table. A random component is generated that is a hash of a random number generated by the one or more random number generators 138. The random component is used as index into the lookup table to determine a chance-based outcome.

In many embodiments, stochastic elements include, but are not limited to, objectives of the hybrid bonus interactive wagering process that one or more players achieve when interacting with the interactive application 110 as described herein. The objectives are generated in accordance with objective logic 134 and one or more outputs from the one or more random number generators 138. In an example embodiment, data of the objectives are stored in a lookup table. A random component is generated that is a hash of a random number generated by the one or more random number generators 138. The random component is used as index into the lookup table to determine an objective.

In various embodiments, stochastic elements include, but are not limited to, application resources of an interactive application that a player uses and/or interacts with during interaction with the interactive application as described herein. The application resources are generated in accordance with resource logic 137 and one or more outputs from the one or more random number generators 138. In an example embodiment, data of application resources are stored in a lookup table. A random component is generated that is a hash of a random number generated by the one or more random number generators 138. The random component is used as index into the lookup table to determine the application resources.

In many embodiments, the wagering subcontroller 136 of the process controller 104 works in association with stochastic element logic 118 of the interactive application 110. In an example embodiment, the wagering subcontroller 136 uses an output of the one or more random number generators 138 along with the stochastic component logic 135 to generate a stochastic component. The stochastic component is then communicated to the interactive controller 102, and the interactive controller uses the stochastic element logic 118 to generate one or more application resources. In other example embodiments, the wagering subcontroller 136 uses the objective logic 134 to provide a selection of an objective that is generated by the interactive controller.

In several embodiments, a rule-based decision engine 131 uses the hybrid bonus interactive wagering telemetry data 150, one or more outputs of the one or more random number generators 138, along with stochastic element logic 118, to generate one or more stochastic elements as described herein. In embodiments, a decision engine 131 includes one or more rules as part of wager processing logic 130 used by a decision engine 131 to determine how a stochastic element should be generated. Each rule includes one or more variable values constituting a pattern that is to be matched by the decision engine 131 to one or more variable values encoded in an input string of data. Each rule also includes one or more actions that are to be taken if the pattern is matched. Actions can include automatically generating one or more stochastic elements in accordance with the stochastic element logic 118 as described herein. During operation, the process controller 104 receives hybrid bonus interactive wagering telemetry data 150 from the interactive controller 102. The wagering subcontroller uses decision engine 131 to perform a matching process of matching the variable values encoded in the hybrid bonus interactive wagering telemetry data 150 to one or more variable patterns of one or more rules. If a match between the variable values and a pattern of a rule is detected, then the wagering subcontroller 136 performs the action of the matched rule.

In various embodiments, the process controller communicates data of one or more stochastic elements generated by the wagering subcontroller 136 to the interactive controller 102 as a portion of the application resource data communicated to the interactive controller 102.

In some embodiments, the decision engine 131 includes one or more rules as part of stochastic element logic 118 used by the decision engine to automatically generate the application resource data that is communicated to the interactive controller 102.

In some embodiments, the interactive application 110 operates utilizing a scripting language. The interactive application 110 parses scripts written in the scripting language and executes commands encoded in the scripts. During a hybrid bonus interactive wagering process of some embodiments, the process controller 104 generates application resources as a stochastic event in the form of scripts written in the scripting language that are communicated to the interactive controller 102 during execution of the interactive application 110. The interactive controller 102 receives the scripts and passes them to the interactive application 110. The interactive application 110 receives the scripts, parses the scripts and automatically executes the commands as encoded in the scripts. In some such embodiments, a lookup table has entries that correspond to a plurality of scripts that are stored in memory store of the processor controller 104. The processor controller 104 generates a random number and uses the random number to create a stochastic component that is an index into the look up table. The process controller 104 uses the index and the look up table to determine a script from among the plurality of scripts, and communicates data of the determined script to the interactive controller.

In some embodiments, application resources include graphical objects that the interactive application utilizes to generate an interactive user interface. In such embodiments, the interactive controller 102 receives the graphical objects and passes them to the interactive application 110. The interactive application 110 receives the graphical objects and uses the graphical objects to generate the interactive user interface. In some such embodiments, a lookup table has entries that correspond to a plurality of graphical objects that are stored in memory store of the processor controller 104. The processor controller 104 generates a random number and uses the random number to create a stochastic component that is an index into the look up table. The process controller 104 uses the index to the look up table to determine a graphical object from among the plurality of graphical objects, and communicates data of the graphical object to the interactive controller.

In many embodiments, the interactive application 110 automatically performs processes as instructed by commands communicated from the process controller 104. The commands command the interactive application 110 to perform specified operations such as executing specified commands and/or setting the values of variables utilized by the interactive application 110. During a hybrid bonus interactive wagering process of some embodiments, the process controller 104 generates commands that are encoded into the application resource data communicated to the interactive controller 102. The interactive controller 102 passes the application resource data to the interactive application 110. The interactive application parses the application resource data and automatically performs operations in accordance with the commands encoded in the application resource data.

In many embodiments, the process controller 104 includes one or more interfaces, such as interface 126, that operatively connect the process controller 104 to one or more external devices used to generate chance-based outcomes, such as central determination controller 145. During a hybrid bonus interactive wagering process, when a wagering subcontroller 136 of the process controller 104 needs a chance-based outcome, the wagering subcontroller communicates a request to the central determination controller 145 for the chance-based outcome. The central determination controller 145 receives the chance-based outcome request and generates a chance-based outcome in response to the chance-based outcome request. The central determination controller communicates data of the chance-based outcome to the process controller 104. The process controller 104 receives the data of the chance-based outcome and utilizes the chance-based outcome as described herein. In some embodiments, the chance-based outcome is drawn from a pool of pre-generated chance-based outcomes.

In various embodiments, the central determination controller 145 is a progressive controller that is operatively connected to a plurality of hybrid bonus interactive wagering systems (not shown). The progressive controller provides services for the collection and provision of credits used by the process controller 104 to provide wagering outcomes that have a progressive or pooling component.

In some embodiments, the process controller 104 includes one or more interfaces, such as interface 128, that operatively connect the process controller 104 to one or more credit input devices, such as credit input devices 144, and to one or more credit output devices, such as credit output devices 146.

In various embodiments, the process controller 104 includes one or more interfaces, such as interface 129, that operatively connect the process controller 104 to one or more ticket-in-ticket-out systems 188 and/or one or more electronic payment systems 190.

The process controller 104 manages one or more wagers in accordance with one or more hybrid bonus interactive wagering processes implemented by the hybrid bonus interactive wagering system 100 by determining a commitment of a wager of value to the hybrid bonus interactive wagering process, executing the hybrid bonus interactive wagering process, and determining a wagering outcome of value of the hybrid bonus interactive wagering process. Types of value committed to the one or more wagers can be one or more of several different types. In various embodiments, types of value of a wager can include, but are not limited to, a wager of an amount of credits corresponding to a real currency or a virtual currency, a wager of an amount of application credits earned through interaction with an interactive application, a wager of an amount of interactive elements of an interactive application, and/or a wager of an amount of objects used in an interactive application. In various embodiments, a type of value of a wagering outcome for a wager committed to a wagering process can be one or more of several different types. In various embodiments, types of value of a wagering outcome can include, but are not limited to, a wagering outcome of an amount of credits corresponding to a real currency or a virtual currency, a wagering outcome of an amount of application credits earned through interaction with an interactive application, a wagering outcome of an amount of interactive elements of an interactive application, and a wagering outcome of an amount of in-application objects used in an interactive application.

In various embodiments, a type of value of a wagering outcome of a hybrid bonus interactive wagering process is different than a type of value of a wager commitment of the hybrid bonus interactive wagering process. In an example embodiment, a value of a wager commitment can be an amount of credits, and a value of a wagering outcome can be an in-application object of an interactive application.

In many embodiments, the process controller 104 includes one or more random number generators (RNGs) having a known stochastic behavior 138 for generating non-deterministic random numbers having a known probability distribution. The wagering subcontroller 136 uses outputs from the one or more random number generators 138 along with the stochastic element logic 118 to generate one or more stochastic elements as described herein.

In many embodiments, the one or more random number generators 138 generate random numbers by continuously generating pseudorandom numbers using one or more pseudorandom number generators. A most current pseudorandom number is stored in a buffer thus constantly refreshing the buffer. In many embodiments, the buffer is refreshed at a rate of approximately 100 times per second. When the wagering subcontroller 136 requests a random number to be used to generate a stochastic element, a random number generator outputs the stored most current pseudorandom number from the buffer. As timing between the requests for a random number is non-deterministic, the resulting output from the buffer is a true non-deterministic random number. In some embodiments, a random number generator includes a plurality of pseudorandom number generators that generate and store pseudorandom numbers into a respective plurality of buffers wherein each of the pseudorandom number generators is seeded with a different seed. When a request is made for a random number, the random number generator generates an additional pseudorandom number and on the basis of the additional pseudorandom number, randomly selects a respective buffer to output the requested random number. In some embodiments, a respective buffer is randomly chosen by hashing a value from a real-time clock circuit to create a random index value that is then used to select from between the respective buffers.

In some embodiments, a stochastic component is generated by a hybrid bonus interactive wagering system by executing stochastic component generation instructions included in stochastic component logic to generate a stochastic component from one or more random numbers output from one or more random number generators. In various embodiments, the stochastic component is a random number in which case the stochastic component generation instructions include instructions to simply pass a random number generated by the random number generator with no additional processing.

In some embodiments, the stochastic component is a hash of a random number output by a random number generator in order to reduce the range of values of the random number so that the stochastic component can be used as an index into a lookup table or the like in which case the stochastic component generation instructions include instructions to hash the output of the random number generator using a hash function.

In some embodiments, an objective is generated by a hybrid bonus interactive wagering system by executing objective generation commands included in objective logic that define processes of a hybrid bonus interactive wagering process where the objective generation commands are formatted in a scripting language. During a hybrid bonus interactive wagering process, a decision engine of a process controller generates the objective generation commands in the form of a script written in the scripting language. The script includes the objective generation commands that describe how the wagering subcontroller is to generate data of an objective. The wagering subcontroller parses the script encoded in the objective generation command data and executes the commands included in the script to generate data of the objective.

In some embodiments, an objective is generated by a hybrid bonus interactive wagering system by executing objective generation commands included in objective logic to generate a stochastic component and use the stochastic component as in index into a lookup table having stored data of a plurality of objectives.

In some embodiments, an objective is generated by a hybrid bonus interactive wagering system by executing objective generation instructions included in objective logic to generate a stochastic component and use the stochastic component in one or more conditional statements of the objective generation instructions to control generation of data of one or more objectives.

In some embodiments, a chance-based outcome is generated by a hybrid bonus interactive wagering system by executing chance-based outcome generation commands included in chance-based outcome logic to generate a stochastic component and use the stochastic component as in index into a lookup table having stored data of a plurality of chance-based outcomes. The chance-based outcomes can be of any type of value. In various embodiments, types of value of a chance-based outcome can include, but are not limited to, an amount of credits corresponding to a real currency or a virtual currency, an amount of application credits earned through interaction with an interactive application, an amount of interactive elements of an interactive application, and/or an amount of objects used in an interactive application.

In various embodiments, a process controller uses a rule-based decision engine to automatically generate an amount of application credits to award to a player based at least in part on hybrid bonus interactive wagering telemetry data including award state data and player interaction data with an interactive application of the hybrid bonus interactive wagering system. In numerous embodiments, the interactive application is a skill-based interactive application and the application credits are awarded for a player's skillful interaction with the interactive application.

In several embodiments, the process controller 104 includes a metering subcontroller 140. The metering subcontroller 140 communicates with the credit processing subcontroller 105 to receive incoming credit data from the credit processing subcontroller 105. The metering subcontroller 140 uses the incoming credit data to transfer credits into the hybrid bonus interactive wagering system and onto one or more credit meters 142 associated with one or more players. The metering subcontroller 140 communicates outgoing credit data to the credit processing subcontroller 105 to transfer credits off of the one or more credit meters 142 and out of the hybrid bonus interactive wagering system.

In various embodiments, the credit process subcontroller 105 and metering subcontroller 140 process types of value committed to the one or more wagers other than credits. In embodiments, the types of value can be one or more of several different types including, but not limited to, credits corresponding to a real currency or a virtual currency, application credits earned through interaction with an interactive application, interactive elements of an interactive application, and/or objects used in an interactive application.

In some embodiments, the wagering subcontroller 136 uses a wagering user interface generator 148 to automatically generate wagering telemetry data 150 on the basis of amounts of credits on the one or more credit meters 142. The wagering telemetry data 150 is used by the process controller 104 to command the interactive controller 102 to automatically generate one or more wagering user interfaces 152 having a display describing a state of wagered credit accumulation and loss for the hybrid bonus interactive wagering system. When a player interacts with the one or more wagering user interfaces 152, wagering user interface telemetry data 150 is generated by the one or more wagering user interfaces 152 and communicated by the interactive controller 102 to the process controller 104 using interfaces 122 and 124.

In some embodiments, the wagering telemetry data 150 may include, but is not limited to, amounts of application credits and interactive elements earned, lost or accumulated through interaction with the interactive application 110, and credits, application credits and interactive elements amounts won, lost or accumulated.

In some embodiments, application resource data are communicated to the wagering user interface generator 148 and used as a partial basis for generation of the wagering telemetry data 150 communicated to the interactive controller 102.

In various embodiments, the wagering user interface generator 148 also receives hybrid bonus interactive wagering process state data that is used as a partial basis for generation of the wagering telemetry data 150 communicated to the interactive controller 102. In some embodiments, the hybrid bonus interactive wagering process state data includes stochastic element data generated by the wagering subcontroller 136 during the generation of stochastic elements. In various embodiments, the wagering user interface generator 148 generates a stochastic element generation display using the one or more states of the hybrid bonus interactive wagering process. The stochastic element generation display is included in the wagering telemetry data 150 that is communicated to the interactive controller 102. The stochastic element generation display is automatically displayed by the interactive controller 102 using the one or more wagering user interfaces 152. In other embodiments, the hybrid bonus interactive wagering process state data are communicated to the interactive controller 102 and the interactive controller 102 is instructed to automatically generate the stochastic element generation display of the one or more wagering user interfaces 152.

In some embodiments, the hybrid bonus interactive wagering process state data includes, but is not limited to, a final state, an intermediate state, a beginning state, and/or an award state of the hybrid bonus interactive wagering process. In an example embodiment, in a hybrid bonus interactive wagering process that is based on slot machine math, the final state of the hybrid bonus interactive wagering process may be reel positions, in a hybrid bonus interactive wagering process that is based on roulette wheel math, the final state may be a pocket where a ball may have come to rest, in a hybrid bonus interactive wagering process that is a based on card math, the beginning, intermediate and final states may represent a sequence of cards being drawn from a deck of cards, etc.

In some embodiments, an interactive controller generates a wagering user interface by executing commands that define processes of the wagering user interface where the commands are formatted in a scripting language. During a hybrid bonus interactive wagering process, a wagering user interface generator of a process controller generates commands in the form of a script written in the scripting language. The script includes commands that describe how the interactive controller is to display hybrid bonus interactive wagering process state data. The completed script is encoded as wagering telemetry data and communicated to the interactive controller by the process controller. The interactive controller receives the wagering telemetry data and parses the script encoded in the wagering telemetry data and executes the commands included in the script to generate the wagering user interface.

In many embodiments, an interactive controller generates a wagering user interface based on a document written in a document markup language that includes commands that define processes of the wagering user interface. During a hybrid bonus interactive wagering process, a wagering user interface generator of a process controller generates a document composed in the document markup language. The document includes commands that describe how the interactive controller is to display hybrid bonus interactive wagering process state data. The completed document is encoded as wagering telemetry data and communicated to the interactive controller by the process controller. The interactive controller receives the wagering telemetry data and parses the document encoded in the wagering telemetry data and executes the commands encoded into the document to generate the wagering user interface.

In some embodiments, an interactive controller generates a wagering user interface by executing commands that define processes of the wagering user interface. During a hybrid bonus interactive wagering process, a wagering user interface generator of a process controller generates the commands and encodes the commands into wagering telemetry data that is communicated to the interactive controller by the process controller. The interactive controller receives the wagering telemetry data and executes the commands encoded in the wagering telemetry data to generate the wagering user interface.

In various embodiments, an interactive controller includes a data store of graphic display and audio presentation resources that the interactive controller uses to generate a wagering user interface as described herein.

In many embodiments, a process controller communicates graphic display and audio presentation resources as part of wagering telemetry data to an interactive controller. The interactive controller uses the graphic display and audio presentation resources to generate a wagering user interface as described herein.

In various embodiments, the wagering user interface generator 148 processes various types of value committed to one or more wagers. In embodiments, the types of value can be one or more of several different types including, but not limited to, credits corresponding to a real currency or a virtual currency, application credits earned through interaction with an interactive application, interactive elements of an interactive application, and/or objects used in an interactive application.

In some embodiments, the process controller 104 utilizes the one or more wagering user interfaces 152 to display certain interactive application data to the player, including but not limited to, club points, player status, control of the selection of choices, and messages which a player can find useful in order to adjust the interactive application experience or understand the wagering status of the player.

In some embodiments, the process controller 104 utilizes the one or more wagering user interfaces 152 to display aspects of a hybrid bonus interactive wagering process to a player including, but not limited to, amount of credits, application credits, interactive elements, or objects in play, and amounts of credits, application credits, interactive elements, or objects available.

In a number of embodiments, the wagering subcontroller 136 can accept hybrid bonus interactive wagering process factors including, but not limited to, modifications in the amount of credits, application credits, interactive elements, or objects wagered on each individual wagering event, entrance into a bonus round, and other factors. In several embodiments, the process controller 104 can communicate a number of factors back and forth to the wagering subcontroller, so that an increase/decrease in a wagered amount can be related to the change in player profile of the player in the interactive application. In this manner, a player can control a wager amount per wagering event in accordance with the hybrid bonus interactive wagering process with the change mapping to a parameter or component that is applicable to the interactive application experience.

In some embodiments, the process controller 104 includes a session subcontroller 154 is used to regulate a hybrid bonus interactive wagering system session. In various embodiments, components of the process controller 104 communicate session data to the session subcontroller 154. The session data may include, but is not limited to, player data, interactive controller data, pooled bet and side bet data, process controller data and wagering subcontroller data used by the session subcontroller to regulate a hybrid bonus interactive wagering system session.

In some embodiments, the session subcontroller 154 may also assert control of a hybrid bonus interactive wagering system session by communicating session control data to components of the process controller 104. Such control may include, but is not limited to, commanding the process controller 104 to end a hybrid bonus interactive wagering system session, initiating wagering in a hybrid bonus interactive wagering system session, ending wagering in a hybrid bonus interactive wagering system session but not ending a player's use of the interactive application portion of the hybrid bonus interactive wagering system, and changing from real credit wagering in a hybrid bonus interactive wagering system to virtual credit wagering, or vice versa.

In many embodiments, the session subcontroller 154 manages player profiles for a plurality of players. The session subcontroller 154 stores and manages data about players in order to provide authentication and authorization of players of the hybrid bonus interactive wagering system 100. In some embodiments, the session subcontroller 154 also manages geolocation information to ensure that the hybrid bonus interactive wagering system 100 is only used by players in jurisdictions were wagering is approved. In various embodiments, the session subcontroller 154 stores application credits that are associated with the player's use of the interactive application of the hybrid bonus interactive wagering system 100.

In some embodiments, the session subcontroller 154 communicates player and session management data to the player using a management user interface (not shown) of the interactive controller. The player interacts with the management user interface and the management user interface generates management telemetry data that is communicated to the session subcontroller 154.

In some embodiments, the wagering subcontroller 136 communicates hybrid bonus interactive wagering session data to the session subcontroller 154. In various embodiments, the session subcontroller communicates hybrid bonus interactive wagering session control data to the wagering subcontroller 136.

In many embodiments, the credit processing subcontroller 105 operatively connects to one or more credit input devices for generating incoming credit data from a credit input. Credit inputs can include, but are not limited to, credit items used to transfer credits. The incoming credit data are communicated by the credit processing subcontroller 105 to the metering subcontroller 140. In various embodiments, the one or more credit input devices and the corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing subcontroller 105 includes one or more credit output devices 146 for generating a credit output based on outgoing credit data 192 communicated from the wagering subcontroller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing subcontroller 105 is operatively connected to, and communicates with, a TITO system 188 or the like to determine incoming credit data representing amounts of credits to be transferred into the hybrid bonus interactive wagering system and to determine outgoing credit data representing amounts of credits to be transferred out of the hybrid bonus interactive wagering system. During a hybrid bonus interactive wagering process, the credit processing subcontroller 105 communicates with a connected credit input device, such as a bill validator/ticket scanner, used to scan a credit input in the form of a TITO ticket having indicia of credit account data of a credit account of the TITO system. The credit processing subcontroller 105 communicates the credit account data to the TITO system. The TITO system uses the credit account data to determine an amount of credits to transfer to the credit processing subcontroller 105, and thus to the metering subcontroller 140 of the process controller 104. The TITO system communicates the amount of credits to the credit processing subcontroller 105. The credit processing subcontroller 105 communicates the amount of credits as incoming credit data to the metering subcontroller 140 and the metering subcontroller 140 credits one or more credit meters 142 with the amount of credits so that the credits can be used when a player makes wagers using the hybrid bonus interactive wagering system 100.

In many embodiments, the credit processing subcontroller 105 is operatively connected to a bill validator/ticket scanner as one of the one or more credit input devices 144. The credit processing subcontroller 105 communicates with the bill validator/ticket scanner to scan currency used as a credit input to determine an amount of credits as incoming credit data to transfer credit to one or more credit meters 110 associated with one or more players. The skill metering subcontroller 140 credits the one or more credit meters 110 with the amount of credits so that the credits can be used when a player makes wagers using the hybrid bonus interactive wagering system 100.

In some embodiments, the credit processing subcontroller 105 can use a TITO system along with a ticket or voucher printer as one of the one or more credit output devices 146 to generate a TITO ticket as a credit output for a player. During a hybrid bonus interactive wagering process, the credit processing subcontroller 105 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing subcontroller 105. The credit processing subcontroller 105 uses the ticket or voucher printer to print indicia of the credit account data onto a TITO ticket or voucher as a credit output.

In various embodiments, a credit processing interface 156 resident in the credit processing subcontroller 105 provides an interface between the credit processing subcontroller 156 and the process controller 104.

In some embodiments, the credit processing interface 156 implements a credit processing subcontroller to process controller communication protocol employing an interprocess communication protocol so that the process controller 104 and the credit processing subcontroller 105 may be implemented on the same device. During a hybrid bonus interactive wagering process, the credit processing interface 156 provides application programming interfaces that are used by the credit processing subcontroller 105 to communicate outgoing data and receive incoming data by passing parameter data to another process or application.

In some embodiments, the credit processing interface 156 implements process controller to credit processing subcontroller communication protocol employing an interdevice communication protocol so that the process controller and the credit processing subcontroller may be implemented on different devices. The interdevice protocol may utilize a wired communication bus or wireless network as a physical layer.

In various embodiments, the credit processing interface 156 implements a process controller to credit processing subcontroller communication protocol employing a networking protocol so that the process controller 104 and the credit processing subcontroller 105 may be implemented on different devices connected by a network. The networking protocol may utilize a wired communication bus or wireless network as a physical layer. During operation, the credit processing interface 156 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the credit processing subcontroller 105 provides an interface to an electronic payment management system 190 such as an electronic wallet or the like. The electronic payment system provides credit account data that is used for generating incoming credit data as a credit input and outgoing credit data as a credit output.

In several embodiments, during operation, the metering subcontroller 140 communicates with the credit processing subcontroller 105 to receive incoming credit data from the credit processing subcontroller 105 and adds credits onto the one or more credit meters 110 at least partially on the basis of the incoming credit data. The wagering subcontroller 136 uses the interactive stochastic element logic 118 and outputs from the one or more random number generators 138 to generate one or more stochastic elements. Data of the one or more stochastic elements are communicated by the process controller 104, as part of hybrid bonus interactive wagering telemetry data 150, to the interactive controller 102. The interactive application 110 uses the stochastic element data to generate an interactive user interface for the player including the one or more interactive user interfaces 112. One or more players interact with the one or more interactive user interfaces 112 through the one or more user interface input and output devices 114. The interactive application 110 detects the player interactions and determines one or more interactive intermediate states based on the detected interactions of the one or more players using the hybrid bonus interactive wagering process logic 116. The interactive controller 102 communicates data of the interactive intermediate states are part of hybrid bonus interactive wagering telemetry data 150 to the process controller 104. The process controller receives the interactive intermediate state data and uses the interactive intermediate state data and system intermediate state data to determine an award state. The process controller determines a wagering outcome based on the award state data, and instructs the metering subcontroller 140 to add credits to, or deduct credits from, the one or more credit meters 110 based in part on the wagering outcome data. For example, in some embodiments, the metering subcontroller is instructed to add an amount of credits to a credit meter of the one or more credit meters 110 when the wagering outcome indicates a win for a player associated with the credit meter. In various embodiments, the metering subcontroller is instructed to deduct an amount of credits from the credit meter when the wagering outcome data indicates a loss for the player. At an end of a hybrid bonus interactive wagering session, the metering subcontroller 140 transfers credits off of the one or more credit meters 110 and out of the hybrid bonus interactive wagering system by communicating outgoing credit data to the credit processing subcontroller 105. The credit processing subcontroller 105 uses the outgoing credit data to generate one or more credit output items using the one or more credit output devices 146.

In another embodiment, a hybrid bonus interactive wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many embodiments, one or more components of a hybrid bonus interactive wagering system are distributed in close proximity to each other and communicate using a local area network and/or a communication bus. In several embodiments, an interactive controller and a process controller of a hybrid bonus interactive wagering system are in a common location.

In various embodiments, these multiple controllers and subcontrollers can be constructed from or configured using a single device or a plurality of devices so that a hybrid bonus interactive wagering system is executed as a system in a virtualized space such as, but not limited to, where a wagering subcontroller and a process controller are large scale centralized servers and are operatively connected to distributed interactive controllers via a wide area network such as the Internet or a local area network. In some embodiments, the components of a hybrid bonus interactive wagering system may communicate using a networking protocol or other type of device-to-device communications protocol.

In various embodiments of a hybrid bonus interactive wagering process, an interactive application may require extensive processing resources from an interactive controller leaving few processing resources for the functions performed by a process controller and/or a wagering subcontroller. By virtue of the architecture described herein, processing loads may be distributed across multiple devices so that operations of the interactive controller may be dedicated to the interactive application and the operations of the process controller and/or wagering subcontroller are not burdened by the requirements of the interactive application, thus improving the functioning of both the interactive controller and the process controller.

In another embodiment, a single process controller may provide services to two or more interactive controllers, thus allowing a hybrid bonus interactive wagering system to operate more efficiently over a large range of scaling.

In another embodiment, multiple types of interactive controllers using different operating systems may be interfaced to a single type of process controller without requiring customization of the process controller, thus improving the efficiency of the process controller by reducing complexity associated with maintaining separate process controllers for each type of interactive controller.

In another embodiment, an interactive controller may be provided as a player device under control of a player while maintaining the process controller in an environment under the control of a regulated operator of wagering systems.

In another embodiment, data communicated between the controllers may be encrypted to increase security of the hybrid bonus interactive wagering system.

In another embodiment, processing loads associated with the hybrid bonus interactive wagering process are distributed across multiple devices so that operations of the interactive controller may be dedicated to an interactive application and the processes of the process controller are not burdened by the requirements of the interactive application.

In another embodiment, an interactive controller is an interactive application server acting as a host for managing head-to-head player interactions over a network of interactive subcontrollers connected to the interactive server using a communication link. The interactive server provides a distributed environment where players can compete directly with one another and interact with other players.

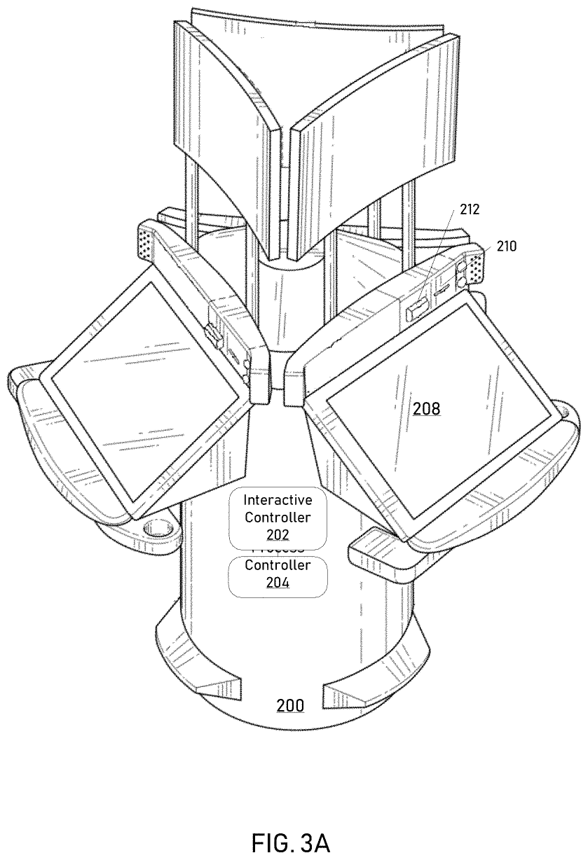

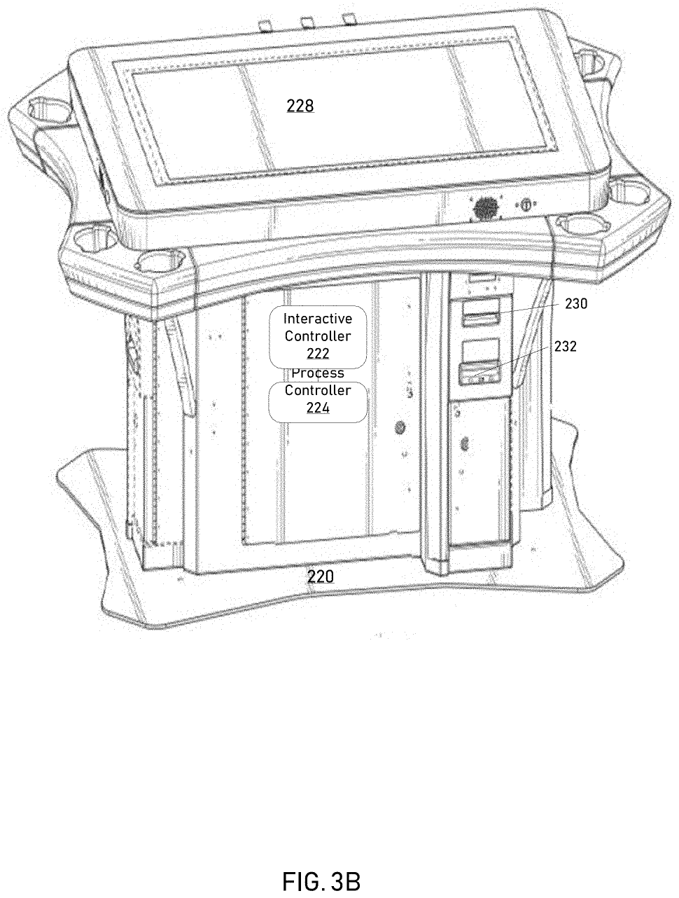

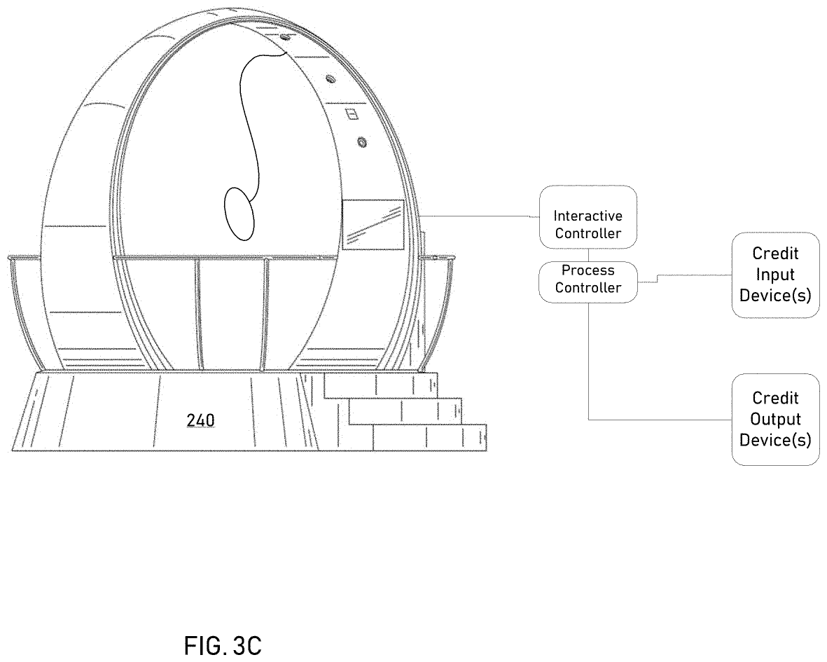

FIG. 3A is a diagram of an electronic gaming machine configuration of a hybrid bonus interactive wagering system in accordance with various embodiments of the invention. Electronic gaming machine configurations of a hybrid bonus interactive wagering system include, but are not limited to, electronic gaming machines such as slot machines, table games, video arcade consoles and the like. An electronic gaming machine configuration of a hybrid bonus interactive wagering system 200 includes an interactive controller 202 as described herein and a process controller 204 as described herein housed in an enclosure such as a housing, cabinet, casing or the like. The enclosure may further include one or more player accessible openings or surfaces that may be used to mount one or more player accessible user input devices and user output devices 208 as described herein, one or more player accessible credit input devices 210 and one or more player accessible credit output devices 212 as described herein. The interactive controller 202 communicates with the user input devices to detect player interactions with the hybrid bonus interactive wagering system and commands and controls the user output devices to provide a user interface to one or more players of the hybrid bonus interactive wagering system as described herein. The process controller 204 communicates using a credit processing subcontroller to one or more player credit processing devices, such as credit input device 210 and credit output device 212 to transfer credits into and out of the hybrid bonus interactive wagering system as described herein.

In various embodiments, the process controller 204 uses a credit processing subcontroller operatively connected to one or more credit input devices 210 for generating incoming credit data from a credit input as described herein.

In various embodiments, the credit processing subcontroller is operatively connected to the one or more credit output devices 212 for generating a credit output based on outgoing credit data communicated from the process controller 204 as described herein.

In some embodiments, the credit processing subcontroller is operatively connected to, and communicates with, a TITO system (not shown) or the like to determine incoming credit data representing amounts of credits to be transferred into the hybrid bonus interactive wagering system 200 and to generate outgoing credit data representing amounts of credits to be transferred out of the hybrid bonus interactive wagering system 200 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the process controller 204 is operatively connected to a central determination controller (not shown) as described herein.

In various embodiments, the process controller 204 may be operatively connected to a progressive controller along (not shown) with one or more other process controllers of one or more other hybrid bonus interactive wagering systems as described herein.

FIG. 3B is a diagram of multiplayer or multiplayer electronic gaming machine configuration of a hybrid bonus interactive wagering system in accordance with various embodiments of the invention. Types of an electronic gaming machine configuration a hybrid bonus interactive wagering system include, but are not limited to, single player or multiplayer electronic gaming machines, single player or multiplayer slot machines, single player or multiplayer table gaming devices, single player or multiplayer video arcade consoles, and the like. An electronic gaming machine configuration of a hybrid bonus interactive wagering system 220 includes an interactive controller 222 as described herein and a process controller 224 as described herein housed in an enclosure such as a housing, cabinet, casing or the like. The enclosure may further include one or more player accessible openings or surfaces that may be used to mount one or more player accessible user input devices and user output devices 228 as described herein, one or more player accessible credit input devices 230 as described herein, and one or more player accessible credit output devices 232 as described herein.

In some embodiments, two or more sets of credit input devices and credit output devices are provided so that each player of the multiplayer or multiplayer electronic gaming machine configuration of a hybrid bonus interactive wagering system 220 can have an associated set of credit input devices and credit output devices.

The interactive controller 222 communicates with the user input devices to detect player interactions with the hybrid bonus interactive wagering system and commands and controls the user output devices to provide a user interface to one or more players of the hybrid bonus interactive wagering system as described herein. The process controller 224 communicates with the credit processing subcontroller 226 or player credit processing devices 230 and 232 to transfer credits into and out of the hybrid bonus interactive wagering system as described herein.

In various embodiments, the process controller 224 uses a credit processing subcontroller operatively connected to one or more credit input devices 230 for generating incoming credit data from a credit input as described herein.

In various embodiments, the credit processing subcontroller is operatively connected to the one or more credit output devices 232 for generating a credit output based on outgoing credit data communicated from the process controller 224 as described herein.

In some embodiments, the credit processing subcontroller is operatively connected to, and communicates with, a TITO system (not shown) or the like to determine incoming credit data representing amounts of credits to be transferred into the hybrid bonus interactive wagering system 220 and to generate outgoing credit data representing amounts of credits to be transferred out of the hybrid bonus interactive wagering system 220 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the process controller 224 is operatively connected to a central determination controller (not shown) as described herein.

In various embodiments, the process controller 224 may be operatively connected to a progressive controller along (not shown) with one or more other process controllers of one or more other hybrid bonus interactive wagering systems as described herein.

FIG. 3C is a diagram of virtual reality gaming machine configuration of a hybrid bonus interactive wagering system in accordance with various embodiments of the invention. Types of a virtual reality gaming machine configuration of a hybrid bonus interactive wagering system include, but are not limited to, virtual reality gaming machines, virtual reality slot machines, virtual reality gaming devices, virtual reality arcade consoles and the like. A virtual reality gaming machine 240 configuration of a hybrid bonus interactive wagering system includes an interactive controller, a process controller and a credit processing subcontroller contained in an enclosure such as a housing, cabinet, casing or the like. The enclosure may further include one or more player accessible openings or surfaces that may be used to mount one or more player accessible user input devices and user output devices, one or more player accessible credit input devices and one or more player accessible credit output devices.

A virtual reality gaming machine configuration of a hybrid bonus interactive wagering system further includes a player area having virtual reality sensors for sensing player interactions and/or player movements within the player area, a player headset having a stereoscopic visual display for display of a stereoscopic interactive user interface to a player, headphones for presenting a stereophonic sound presentation to a player, and one or more subwoofers for providing a hepatic or low frequency auditory presentation to the player.

The interactive controller communicates with the user input devices to detect player interactions with the virtual reality hybrid bonus interactive wagering system and commands and controls the user output devices to provide a user interface to one or more players of the virtual reality hybrid bonus interactive wagering system as described herein. The process controller communicates with the credit processing subcontroller or player credit processing devices and to transfer credits into and out of the hybrid bonus interactive wagering system as described herein.

In many embodiments, the process controller is further connected to one or more side betting terminals that enable spectators of a player using the virtual reality hybrid bonus interactive wagering system to make side bets based on the performance of the player.

In various embodiments, the process controller 224 uses a credit processing subcontroller operatively connected to one or more credit input devices 230 for generating incoming credit data from a credit input as described herein.

In various embodiments, the credit processing subcontroller is operatively connected to the one or more credit output devices 232 for generating a credit output based on outgoing credit data communicated from the process controller 224 as described herein.

In some embodiments, the credit processing subcontroller is operatively connected to, and communicates with, a TITO system (not shown) or the like to determine incoming credit data representing amounts of credits to be transferred into the hybrid bonus interactive wagering system 220 and to generate outgoing credit data representing amounts of credits to be transferred out of the hybrid bonus interactive wagering system 220 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the process controller 224 is operatively connected to a central determination controller (not shown) as described herein.

In various embodiments, the process controller 224 may be operatively connected to a progressive controller along (not shown) with one or more other process controllers of one or more other hybrid bonus interactive wagering systems as described herein.

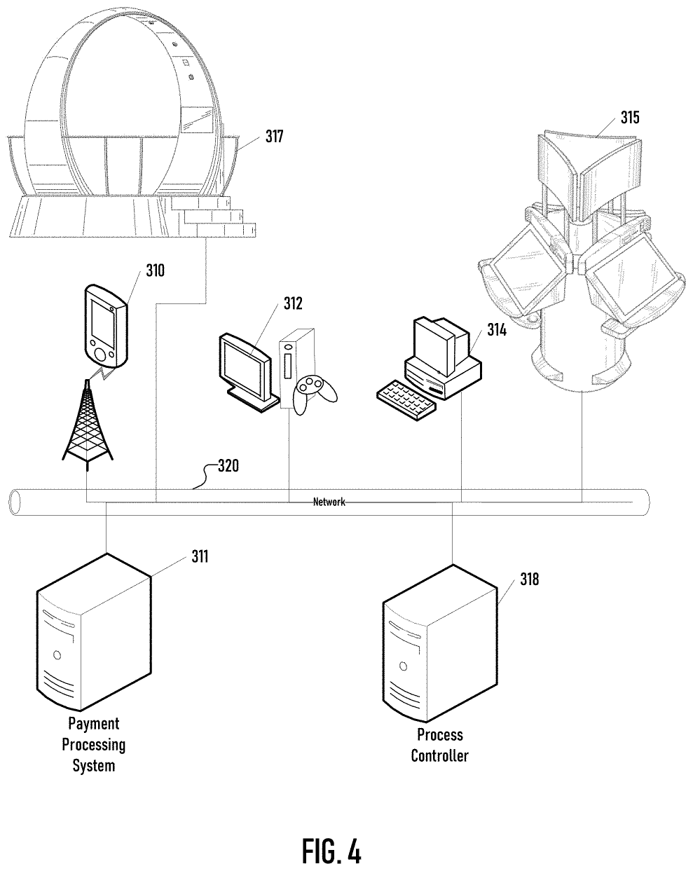

FIG. 4 is a diagram of distributed hybrid bonus interactive wagering systems in accordance with various embodiments of the invention. An interactive controller, such as interactive controller 102 of FIG. 2, may be constructed from or configured using one or more processing devices that perform the operations of the interactive controller. An interactive controller in a distributed hybrid bonus interactive wagering system may be constructed from or configured using any processing device having sufficient processing and communication capabilities to perform the processes of an interactive controller in accordance with various embodiments of the invention. In some embodiments, the construction or configuration of the interactive controller may be achieved through the use of an application control interface, such as application control interface 122 of FIG. 2, and/or through the use of an interactive application, such as interactive application 110 of FIG. 2.

In many embodiments, a hybrid bonus interactive wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of a hybrid bonus interactive wagering system are distributed in close proximity to each other and communicate using a local area network and/or a communication bus. In several embodiments, an interactive controller and a process controller of a hybrid bonus interactive wagering system are in a common location and communicate with an external wagering subcontroller. In some embodiments, a process controller and a wagering subcontroller of a hybrid bonus interactive wagering system are in a common location and communicate with an external interactive controller. In many embodiments, an interactive controller, a process controller, and a wagering subcontroller of a hybrid bonus interactive wagering system are located in a common location. In some embodiments, a session subcontroller is located in a common location with a process controller and/or a wagering subcontroller.

In various embodiments, these multiple devices can be constructed from or configured using a single device or a plurality of devices so that a hybrid bonus interactive wagering system is executed as a system in a virtualized space such as, but not limited to, where a process controller is a large scale centralized server in a cloud networking environment operatively connected to widely distributed interactive controllers via a wide area network such as the Internet or a local area network. In embodiments, the components of a hybrid bonus interactive wagering system may communicate using a networking protocol or other type of device-to-device communications protocol.

In some embodiments, a hybrid bonus interactive wagering system is deployed over a local area network or a wide area network in a mobile configuration. A mobile configuration of a hybrid bonus interactive wagering system is useful for deployment over wireless communication network, such as a wireless local area network or a wireless telecommunications network. A mobile configuration of a hybrid bonus interactive wagering system includes an interactive controller operatively connected by a wireless network to a process controller and a wagering subcontroller.

In numerous embodiments, an interactive application server provides a host for managing head-to-head play operating over a network of interactive controllers connected to the interactive application server using a communication link. The interactive application server provides an environment where players can compete directly with one another and interact with other players.

In some embodiments, an interactive controller may be constructed from or configured using an electronic gaming machine 315, such as a slot machine or the like, or a virtual reality electronic gaming machine 317. The electronic gaming machines may be physically located in various types of gaming establishments.

In many embodiments, an interactive controller may be constructed from or configured using a portable device 310. The portable device 310 is a device that may wirelessly connect to a network. Examples of portable devices include, but are not limited to, a tablet computer, a personal digital assistant, and a smartphone.

In some embodiments, an interactive controller may be constructed from or configured using a video gaming console 312.

In various embodiments, an interactive controller may be constructed from or configured using a personal computer 314.

In some embodiments, one or more processing devices, such as devices 310, 312, 314, 315 and a virtual reality gaming machine may be used to construct a complete hybrid bonus interactive wagering system and may be operatively connected using a communication link to a session and/or management controller.

Some hybrid bonus interactive wagering systems in accordance with many embodiments of the invention can be distributed across a plurality of devices in various configurations. One or more interactive controllers of a distributed hybrid bonus interactive wagering system, such as but not limited to, a mobile or wireless device 310, a gaming console 312, a personal computer 314, an electronic gaming machine 315, and a virtual reality gaming machine are operatively connected with a process controller 318 of a distributed hybrid bonus interactive wagering system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive controller and a process controller as described herein are executed on the individual interactive controllers 310, 312, 314, 315 and a virtual reality gaming machine while one or more processes of a process controller as described herein can be executed by the process controller 318.

In many embodiments, a distributed hybrid bonus interactive wagering system and may be operatively connected using a communication link to a session controller (not shown), that performs the processes of a session controller as described herein.

In several embodiments, a distributed hybrid bonus interactive wagering system and may be operatively connected using a communication link to credit processing system 311, that performs the processes of one or more credit processing systems as described herein.

In some embodiments, a distributed hybrid bonus interactive wagering system allows for the processing of portions of a hybrid bonus interactive wagering process on a non-secure interactive controller that is in the possession of a player while other portions of the hybrid bonus interactive wagering process are processed on a secure process controller in the possession of an operator. This improves the functioning of both controllers as an amount of information that must be transferred across a communications network is reduced.

In some embodiments, a distributed hybrid bonus interactive wagering system can minimize resource starving during the implementation of complex hybrid bonus interactive wagering processes. In an example embodiment, a hybrid bonus interactive wagering process includes randomly spawning interactive game objects in a game space displayed on an interactive user interface displayed to a player. In addition, chance-based outcomes of the hybrid bonus interactive wagering process are generated using system stochastic events. By virtue of a distributed hybrid bonus interactive wagering system the interactive game objects can be spawned on a non-secure interactive controller that may be in the possession of a player, while the chance-based outcomes are generated on a secure device in the possession of a regulated operator. By allocating spawning of the interactive game objects to an interactive controller coupled to a process controller by a secure communications link, data of the spawned interactive game objects need not be communicated over the network, instead, only stochastic components generated by the process controller in a secure environment are needed to be communicated.

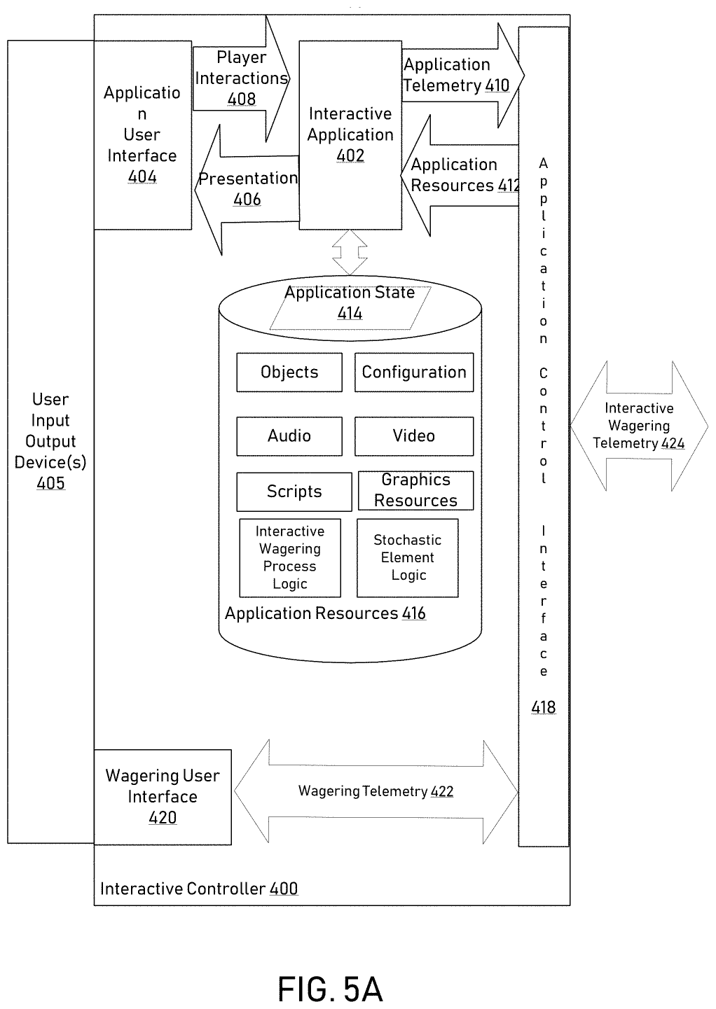

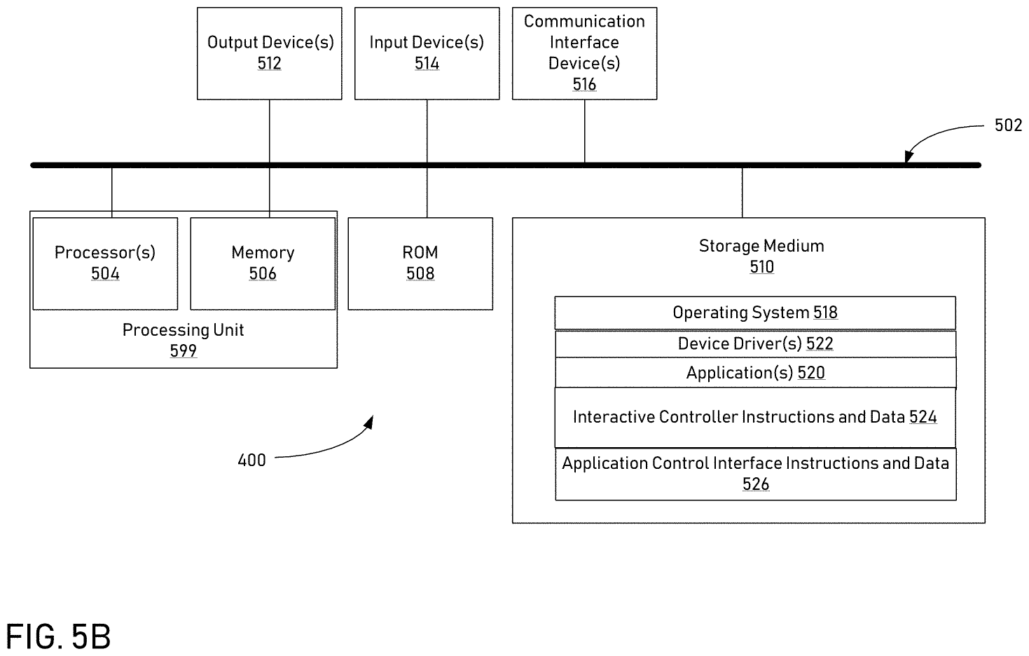

FIGS. 5A and 5B are architecture diagrams of an interactive controller in accordance with various embodiments of the invention. Referring now to FIG. 5A, an interactive controller 400 provides an execution environment for an interactive application 402 of a hybrid bonus interactive wagering system. In several embodiments, an interactive controller 400 of a hybrid bonus interactive wagering system provides an interactive application 402 that generates an application interface 404 for interaction with by one or more players. The interactive application 402 generates an interactive user interface 406 that is presented to the player through the application interface 404 using one or more user input and output devices 405. The interactive user interface 406 may include audio features, visual features or tactile features, or any combination of these features. In various embodiments, the application interface 404 utilizes one or more user interface input and output devices 405 so that a player can interact with the interactive user interface 406. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, ear buds, and the like; visual output devices such as lights, video displays and the like; and tactile devices such as rumble pads, hepatic touch screens, buttons, keys and the like. The player's interactions 408 are included by the interactive application 402 in application telemetry data 410 that is communicated by interactive controller 400 as part of hybrid bonus interactive wagering telemetry data 424 to various other components of a hybrid bonus interactive wagering system as described herein. The interactive application 402 receives application resources 412 communicated as part of hybrid bonus interactive wagering telemetry data 424 from various other components of a hybrid bonus interactive wagering system as described herein. In some embodiments, the hybrid bonus interactive wagering telemetry data 424 may include player interactions with objects of the interactive application and an award state of a hybrid bonus interactive wagering process presented to the player by the interactive application 402.

In some embodiments, various components of the interactive application 402 can read data from an application state 414 in order to provide one or more features of the interactive application. In various embodiments, components of the interactive application 402 can include, but are not limited to: a physics engine; a rules engine; an audio engine; a graphics engine and the like. The physics engine is used to simulate physical interactions between interactive elements in the interactive application 402. The rules engine implements the rules of the interactive application and a random number generator that may be used for influencing or determining certain variables and/or outcomes to provide a randomizing influence on the operations of the interactive application. The graphics engine is used to generate a visual representation of the interactive application state to the player. The audio engine is used to generate an audio representation of the interactive application state to the player.

During operation, the interactive application reads and writes application resources 416 stored on a data store of the interactive controller 400. The application resources 416 may include objects having graphics and/or control logic used to provide interactive elements of the interactive application. In various embodiments, the application resources may also include, but are not limited to, video files that are used to generate a portion of the interactive user interface 406; audio files used to generate music, sound effects, etc. within the interactive application; configuration files used to configure the features of the interactive application; scripts or other types of control code used to provide various features of the interactive application; graphics application resources such as textures, objects, etc. that are used by a graphics engine to render objects displayed in an interactive application; hybrid bonus interactive wagering process logic used to determine one or more states of a hybrid bonus interactive wagering process using player interactions with the interactive user interface; and stochastic element logic used by the interactive application to generate one or more stochastic elements used as application resources.

During a hybrid bonus interactive wagering process, components of the interactive application 402 read portions of the application state 414 and generate the interactive user interface 406 for the player that is presented to the player using the user interface 404. The player perceives the interactive user interface and provides player interactions 408 using the user input devices and user output devices 405. The corresponding player interactions are detected as player actions or inputs by various components of the interactive application 402. The interactive application 402 translates the player actions into interactions with the interactive elements of the interactive application. Components of the interactive application use the player interactions with the interactive elements of the interactive application and the interactive application state 414 to update the application state 414 and update the interactive user interface 406 presented to the player. The process loops continuously while the player interacts with the user interfaces of the interactive application of the hybrid bonus interactive wagering system.

The interactive controller 400 provides one or more interfaces 418 between the interactive controller 400 and other components of a hybrid bonus interactive wagering system, such as, but not limited to, a process controller. The interactive controller 400 and the other hybrid bonus interactive wagering system components communicate with each other using the interface. The interface may be used to pass various types of data, and to communicate and receive messages, status data, commands and the like. In certain embodiments, the interactive controller 400 and a process controller communicate wagering telemetry data 424. In some embodiments, the communications include requests by the process controller that the interactive controller 400 update the application state 414 using data provided by the process controller.

In many embodiments, communications between a process controller and the interactive controller 400 includes a request that the interactive controller 400 update one or more application resources 416 using data provided by the process controller. In a number of embodiments, the interactive controller 400 provides all or a portion of the application state to the process controller. In some embodiments, the interactive controller 400 may also provide data about one or more of the application resources 416 to the process controller. In some embodiments, the communication includes player interactions that the interactive controller 400 communicates to the process controller. The player interactions may be low level player interactions with the user interface 404, such as manipulation of an input device, or may be high level player interactions with game world objects as detected by the interactive application. The player interactions may also include resultant actions such as modifications to the application state 414 or application resources 416 resulting from the player's interactions taken in the hybrid bonus interactive wagering system interactive application. In some embodiments, player interactions include, but are not limited to, actions taken by entities such as non-player characters (NPCs) of the interactive application that act on behalf of or under the control of the player.

In various embodiments, the application resources 412 include application resources used by the interactive application 402 to generate an interactive user interface of a hybrid bonus interactive wagering process presented to a player and to determine intermediate states based on the player's skillful interaction with the interactive user interface. In many embodiments, data of the application resources 412 includes data of one or more stochastic elements as described herein.

In some embodiments, the interactive controller 400 includes a wagering user interface 420 used to provide and receive wagering telemetry data 422 to and from the player. The hybrid bonus interactive wagering system telemetry data 422 from the hybrid bonus interactive wagering system includes, but is not limited to, data used by the player to configure a wager, data used to communicate, as part of hybrid bonus interactive wagering telemetry data 424, a state of a hybrid bonus interactive wagering process, and data about a <type of> interactive wager outcome.

In some embodiments, an interactive controller includes one or more sensors (not shown). Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors (GPSs). The interactive controller communicates sensor telemetry data to one or more components of the hybrid bonus interactive wagering system.

Referring now to FIG. 5B, interactive controller 400 includes a bus 502 that provides an interface for one or more processors 504, random access memory (RAM) 506, read only memory (ROM) 508, machine-readable storage medium 510, one or more user output devices 512 as described herein, one or more user input devices 514 as described herein, and one or more communication interface devices 516 for implementing one or more interfaces as described herein.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive controller processing unit 599. In some embodiments, the interactive controller processing unit includes one or more processors operatively connected to one or more of a RAM, ROM, and machine-readable storage medium; the one or more processors of the interactive controller processing unit receive instructions stored by the one or more of a RAM, ROM, and machine-readable storage medium via a bus; and the one or more processors execute the received instructions. In some embodiments, the interactive controller processing unit is an ASIC (Application-Specific Integrated Circuit). In some embodiments, the interactive controller processing unit is a SoC (System-on-Chip).

The one or more communication interface devices 516 provide one or more wired or wireless interfaces for communicating data and commands between the interactive controller 400 and other devices that may be included in a hybrid bonus interactive wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; one or more device drivers 522; one or more application programs 520 including but not limited to an interactive application; and hybrid bonus interactive wagering system interactive controller instructions and data 524 for use by the one or more processors 504 to provide the features of an interactive controller as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

During a hybrid bonus interactive wagering process, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive controller 400 to provide the features of a hybrid bonus interactive wagering system interactive controller as described herein

Although the interactive controller is described herein as being constructed from or configured using one or more processors and instructions stored and executed by hardware components, the interactive controller can be constructed from or configured using only hardware components in accordance with other embodiments. In addition, although the storage medium 510 is described as being operatively connected to the one or more processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive controller 400 can be distributed across a plurality of different devices. In many embodiments, an interactive controller of a hybrid bonus interactive wagering system includes an interactive application server operatively connected to an interactive client using a communication link. The interactive application server and interactive application client cooperate to provide the features of an interactive controller as described herein.

In various embodiments, the interactive controller 400 may be used to construct other components of a hybrid bonus interactive wagering system as described herein.

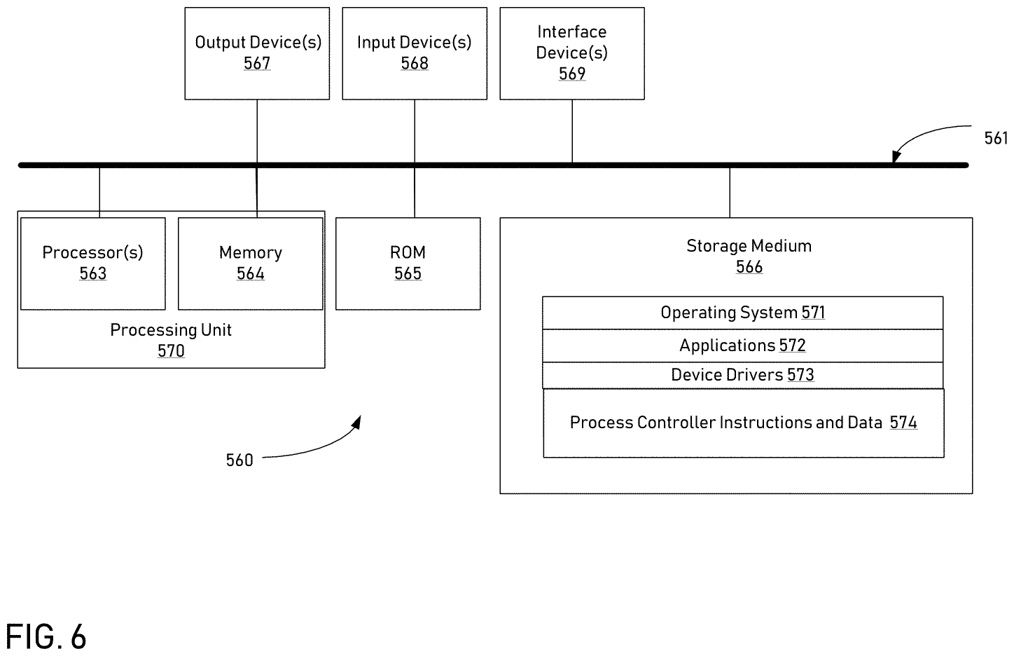

FIG. 6 is an architecture diagram of a process controller of a hybrid bonus interactive wagering system in accordance with various embodiments of the invention. A process controller may be constructed from or configured using one or more processing devices that perform the operations of the process controller. In many embodiments, a process controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Process controller 560 includes a bus 561 providing an interface for one or more processors 563, random access memory (RAM) 564, read only memory (ROM) 565, machine-readable storage medium 566, one or more user output devices 567 as described herein, one or more user input devices 568 as described herein, and one or more communication interface and/or network interface devices 569 used to implement one or more interfaces as described herein.

The one or more processors 563 may take many forms, such as, but not limited to: a central processing unit (CPU); a multi-processor unit (MPU); an ARM processor; a programmable logic device; or the like.

In the example embodiment, the one or more processors 563 and the random access memory (RAM) 564 form a process controller processing unit 570. In some embodiments, the process controller processing unit includes one or more processors operatively connected to one or more of a RAM, ROM, and machine-readable storage medium; the one or more processors of the process controller processing unit receive instructions stored by the one or more of a RAM, ROM, and machine-readable storage medium via a bus; and the one or more processors execute the received instructions. In some embodiments, the process controller processing unit is an ASIC (Application-Specific Integrated Circuit). In some embodiments, the process controller processing unit is a SoC (System-on-Chip).

The one or more communication interface and/or network interface devices 569 provide one or more wired or wireless interfaces for exchanging data and commands between the process controller 560 and other devices that may be included in a hybrid bonus interactive wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 566 stores machine-executable instructions for various components of the process controller 560 such as, but not limited to: an operating system 571; one or more applications 572; one or more device drivers 573; and hybrid bonus interactive wagering system process controller instructions and data 574 for use by the one or more processors 563 to provide the features of a process controller as described herein.

In various embodiments, the machine-readable storage medium 566 is one of a (or a combination of two or more of) a hard drive, a flash drive, a DVD, a CD, a flash storage, a solid state drive, a ROM, an EIEPROM, and the like.

During a hybrid bonus interactive wagering process, the machine-executable instructions are loaded into memory 564 from the machine-readable storage medium 566, the ROM 565 or any other storage location. The respective machine-executable instructions are accessed by the one or more processors 563 via the bus 561, and then executed by the one or more processors 563. Data used by the one or more processors 563 are also stored in memory 564, and the one or more processors 563 access such data during execution of the machine-executable instructions. Execution of the machine-executable instructions causes the one or more processors 563 to control the process controller 560 to provide the features of a hybrid bonus interactive wagering system process controller as described herein.

Although the process controller 560 is described herein as being constructed from or configured using one or more processors and instructions stored and executed by hardware components, the process controller can be composed of only hardware components in accordance with other embodiments. In addition, although the storage medium 566 is described as being operatively connected to the one or more processors through a bus, those skilled in the art of process controllers will understand that the storage medium can include removable media such as, but not limited to, a USB memory device, an optical CD ROM, magnetic media such as tape and disks. Also, in some embodiments, the storage medium 566 may be accessed by processor 563 through one of the interfaces or using a communication link. Furthermore, any of the user input devices or user output devices may be operatively connected to the one or more processors 563 via one of the interfaces or using a communication link.

In various embodiments, the process controller 560 may be used to construct other components of a hybrid bonus interactive wagering system as described herein.

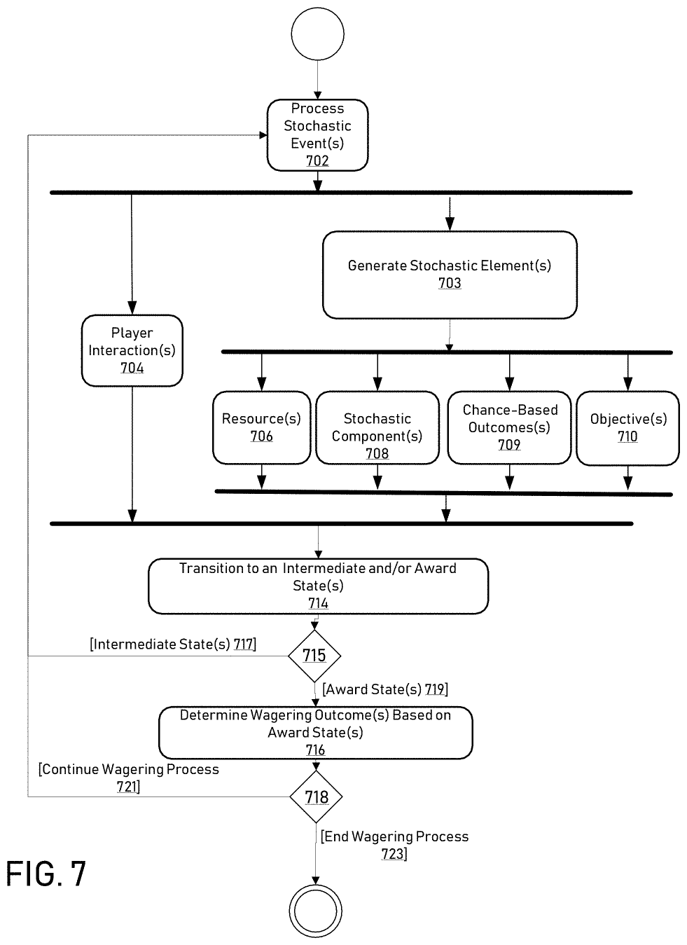

FIG. 7 is an activity diagram illustrating an algorithm of a hybrid bonus interactive wagering process of a hybrid bonus interactive wagering system in accordance with various embodiments of the invention. In many embodiments, a hybrid bonus interactive wagering system determines 716 a wagering outcome for a hybrid bonus interactive wagering process by executing one or more iterations of a hybrid bonus interactive wagering process where the hybrid bonus interactive wagering system detects stochastic events in the form of player interactions and generates stochastic events in the form of stochastic elements as described herein. In an example embodiment, a hybrid bonus interactive wagering process for a number of states of the hybrid bonus interactive wagering process 700, while in a state that is expecting a stochastic transition, the hybrid bonus interactive wagering system processes 702 one or more stochastic events, including but not limited to, one or more interactive stochastic events such as detecting player interactions 704 with an interactive user interfaces that cause a transition to a next state, or may detect one or more system stochastic events such as by generating 703 one or more stochastic elements such as generating one or more application resources 706, generating one or more stochastic components 708, generating one or more chance-based outcomes 709, and/or generating one or more objectives 710, thus causing a transition to a next state. The hybrid bonus interactive wagering system transitions 714 to one or more intermediated and/or award states based one the stochastic events that the hybrid bonus interactive wagering system either detects or generates.

If the hybrid bonus interactive wagering system determines 715 that it is in an intermediate state, the hybrid bonus interactive wagering system continues 717 to process 702 stochastic events. If the hybrid bonus interactive wagering system determines 715 that it is in an award state 719, the hybrid bonus interactive wagering system determines 716 a wagering outcome of value to award for the hybrid bonus interactive wagering process. In various embodiments, a type of value awarded based on a wagering outcome for a wager committed to a hybrid bonus interactive wagering process can be one or more of several different types. In various embodiments, types of value of a wagering outcome can include, but are not limited to, a wagering outcome of an amount of credits corresponding to a real currency or a virtual currency, a wagering outcome of an amount of application credits earned through interaction with an interactive application, a wagering outcome of an amount of interactive elements of an interactive application, and a wagering outcome of an amount of in-application objects used in an interactive application.

If the hybrid bonus interactive wagering system determines 718 that it is to continue the hybrid bonus interactive wagering process, the hybrid bonus interactive wagering system continues 721 to process 702 stochastic events. If the hybrid bonus interactive wagering system determines 718 that it is to end the hybrid bonus interactive wagering process, the hybrid bonus interactive wagering system ends 723 the hybrid bonus interactive wagering process.

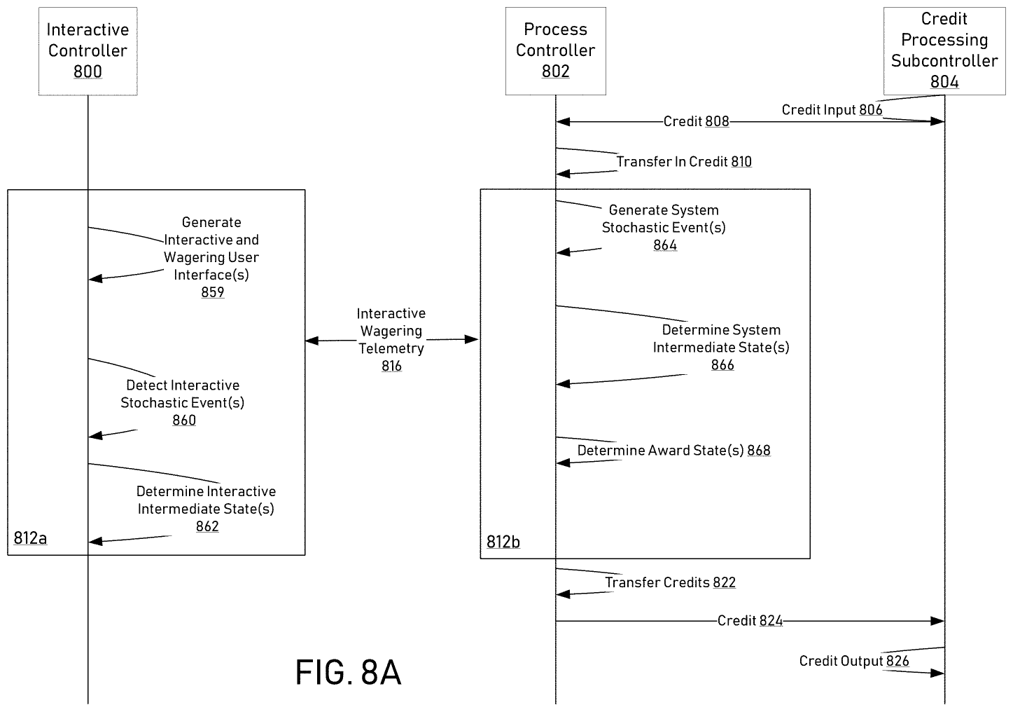

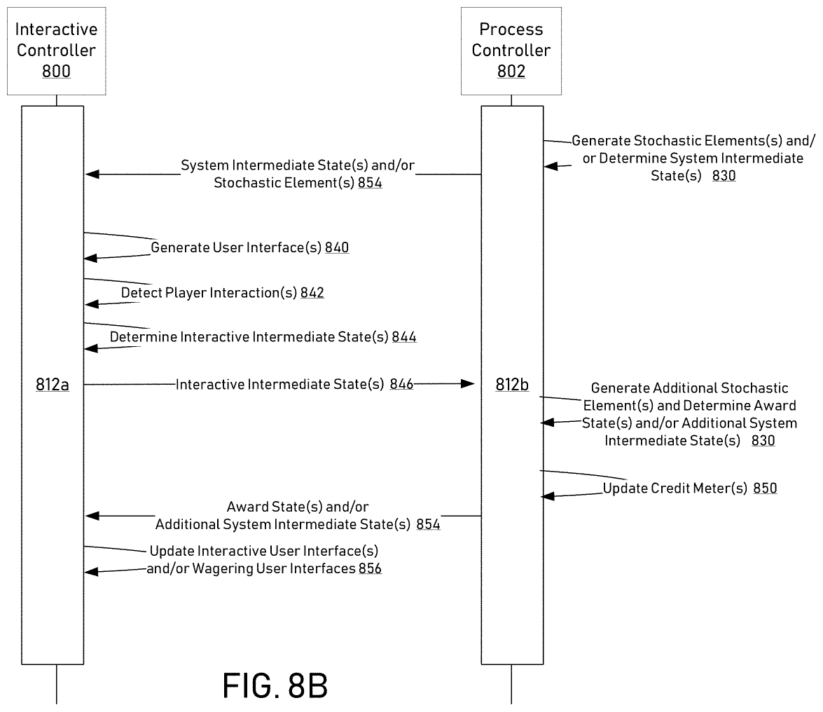

FIGS. 8A and 8B are sequence diagrams illustrating a hybrid bonus interactive wagering process of a hybrid bonus interactive wagering system in accordance with various embodiments of the invention. A hybrid bonus interactive wagering system allows for the management of a hybrid bonus interactive wagering process for one or more players. In some embodiments of a hybrid bonus interactive wagering system, an interactive application executed by an interactive controller provides the hybrid bonus interactive wagering process to the one or more players of the hybrid bonus interactive wagering system. The interactive controller is operatively connected to a process controller that manages crediting and other administrative processes as well as generating one or more stochastic elements and determining one or more system intermediated states. The stochastic elements are communicated to the interactive application for use in the hybrid bonus interactive wagering process. The interactive controller determines one or more interactive intermediate states based on logic of the hybrid bonus interactive wagering process, the one or more stochastic elements, and detection of one or more stochastic player interaction events. The interactive intermediate states are communicated by the interactive controller to the process controller and the process controller uses the interactive intermediate states and the system intermediate states to determine one or more award states representing a wager outcome for the hybrid bonus interactive wagering process.

Referring now to FIG. 8A, in some embodiments, at a beginning of the hybrid bonus interactive wagering session, the process includes a credit input 806 to the hybrid bonus interactive wagering system with a process controller 802 communicating with a credit processing subcontroller 804 to receive incoming credit data 808. The process controller 802 uses the incoming credit data to transfer 810 credits onto one or more player credit meters associated with one or more players of the hybrid bonus interactive wagering system, thus transferring credits into the hybrid bonus interactive wagering system and on to the one or more player credit meters.

During the hybrid bonus interactive wagering process 812a and 812b, the interactive controller 800 and the process controller 802 communicate hybrid bonus interactive wagering telemetry data 816 used by the controllers to implement the hybrid bonus interactive wagering process. The hybrid bonus interactive wagering telemetry data includes, but is not limited to, application telemetry data, wagering telemetry data; interactive intermediate state data; system intermediate state data; and/or award state data. The interactive intermediate state data can include, but is not limited to, requests by the interactive controller 800 for stochastic elements generated by the process controller 802. The system intermediate state data can include, but is not limited to, data of stochastic elements requested by the interactive controller 800 of the process controller 802.

During the hybrid bonus interactive wagering process 812a and 812b, the interactive controller generates 840 interactive user interfaces and/or wagering user interfaces that are displayed to a player. In some embodiments, the interactive controller uses data of application resources, stochastic components, chance-based outcomes, and/or objectives received from the process controller 802 to generate portions of the interactive wager user interfaces and/or wagering user interfaces as described herein.

The interactive controller detects 860 one or more interactive stochastic events in the form of player interactions with one or more interactive elements of the interactive user interfaces and determines 862 one or more interactive intermediate states using the detected one or more interactive stochastic events. The interactive controller 800 communicates data of one or more of the interactive intermediate states to the process controller as part of interactive wagering telemetry 816. The data of the one or more interactive intermediate states may include, but is not limited to, objective achievements, and/or requests for data of stochastic elements generated by the process controller including, but not limited to, application resources, stochastic components, chance-based outcomes, and/or objectives.

In parallel, the process controller receives the data of the one or more interactive intermediate states and generates 864 one or more system stochastic events in the form of stochastic elements in response to receiving data of the one or more interactive intermediate states. The stochastic elements include, but are not limited to, application resources, stochastic components, chance-based outcomes, and/or objectives. The process controller determines 866 one or more system intermediate states from the system stochastic events and communicates to the interactive controller 800, data of the one or more system intermediate states including, but not limited to, requested data for stochastic elements including, but not limited to, application resources, stochastic components, chance-based outcomes, and/or objectives.

The process controller may use the one or more interactive intermediate states 862 received from the interactive controller 800 along with the one or more system intermediate states to determine one or more award states 868. The process controller communicates data of the one or more award states to the interactive controller as part of the interactive wagering telemetry 816.

In many embodiments, upon determining that a hybrid bonus interactive wagering session is completed, such as by receiving a cashout communication from the one or more players of the hybrid bonus interactive wagering system, the process controller 802 transfers 822 credits off of the one or more player credit meters, generates outgoing credit data 824 on the basis of the credits transferred off of the one or more player credit meters, and communicates the outgoing credit data 824 to the credit processing subcontroller 804. The credit processing subcontroller 804 receives the outgoing credit data 824 and generates 826 a credit output as described herein, thus transferring credits off of the one or more player credit meters and out of the hybrid bonus interactive wagering system.

Referring now to FIG. 8B, in slightly more detail, during the hybrid bonus interactive wagering process 812a and 812b, the process controller 802 determines 830 one or more system intermediate states of the hybrid bonus interactive wagering process. As part of the determination of the one or more system intermediate states, the process controller may generate one or more stochastic elements for use by the interactive controller. The process controller communicates data of the one or more system intermediate states and/or stochastic elements to the interactive controller 800. The interactive controller receives data of the one or more system intermediate states and/or stochastic elements and generates 840 one or more interactive user interfaces and one or more wagering user interfaces having interactive elements for interaction with by a player. The interactive controller detects 842 one or more player interactions with the interactive elements of the user interfaces and determines 844 one or more interactive intermediate states using the one or more player interactions. The one or more interactive intermediate states may include data of one or more objective achievements. The interactive controller 800 communicates data of the one or more interactive intermediate states 846 to the process controller 802. The process controller 802 receives the interactive intermediate state data 846. Upon determination by the process controller 802 that a stochastic element is to be generated in accordance with a state of the hybrid bonus interactive wagering process as determined from the one or more system intermediate states and/or one or more interactive intermediate states, the process controller 802 generates 830 one or more additional stochastic elements. When the one or more additional stochastic elements are one or more chance-based outcomes of an amount of credits, the process controller may determine an award state based on the one or more chance-based outcomes or an additional system intermediate state.

The process controller 802 communicates data of the one or more award states, and/or one or more additional system intermediate states 854 to the interactive controller 802. In a case that one or more of the stochastic elements is generated in association with a commitment of an amount of credits to a wager, the process controller 802 updates one or more credit meters to reflect the award of an amount of credits and/or wager commitment of an amount of credits communicates wagering telemetry data to the interactive controller 800 as part of the data of the one or more award states, and/or one or more additional system intermediate states 854.

The interactive controller 800 receives the data of the one or more award states, and/or one or more additional system intermediate states 854 from the process controller 802 and uses any stochastic element data, wagering telemetry data, additional system intermediate state data to update 856 the one or more interactive user interfaces and/or the one or more wagering user interfaces as described herein.

In various embodiments, a process controller provides one or more stochastic components to an interactive controller as part of the system intermediate state data. The interactive controller receives the stochastic components and uses the stochastic components to generate one or more stochastic elements of a hybrid bonus interactive wagering process as described herein.

In some embodiments, at a beginning of the hybrid bonus interactive wagering session, the process includes an application credit input to the hybrid bonus interactive wagering system with the process controller 802 communicating with the credit processing subcontroller 803 to receive incoming application credit data. The process controller 802 uses the incoming application credit data to transfer application credits onto one or more application credit meters associated with one or more players of the hybrid bonus interactive wagering system, thus transferring application credits into the hybrid bonus interactive wagering system and on to the one or more application credit meters. The process controller 802 uses interactive intermediate state data of an interactive application to generate an amount of application credit to award to a player based on the player's achievement of one or more objectives of the interactive application. In an example embodiment, the interactive intermediate state data includes a count of objectives achieved by the player. The player is awarded a specified number of credits for each achieved objective. Upon determining that the hybrid bonus interactive wagering session is completed, such as by receiving a cashout communication from one or more players of the hybrid bonus interactive wagering system, the process controller 802 transfers application credits off of the one or more application credit meters, generates outgoing application credit data on the basis of the application credits transferred off of the one or more application credit meters, and communicates the outgoing application credit data to the credit processing subcontroller 803. The credit processing subcontroller receives the outgoing application credit data and generates an application credit output as described herein, thus transferring application credits off of the one or more application credit meters and out of the hybrid bonus interactive wagering system.

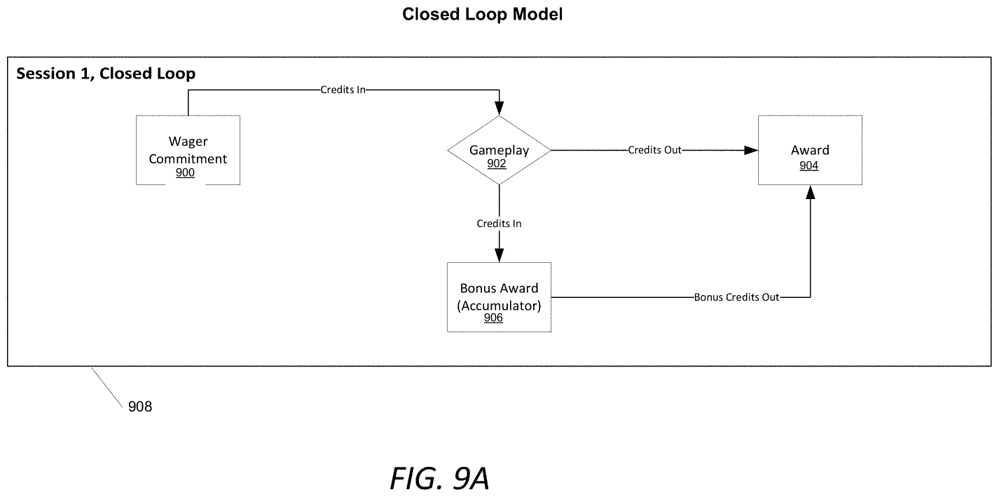

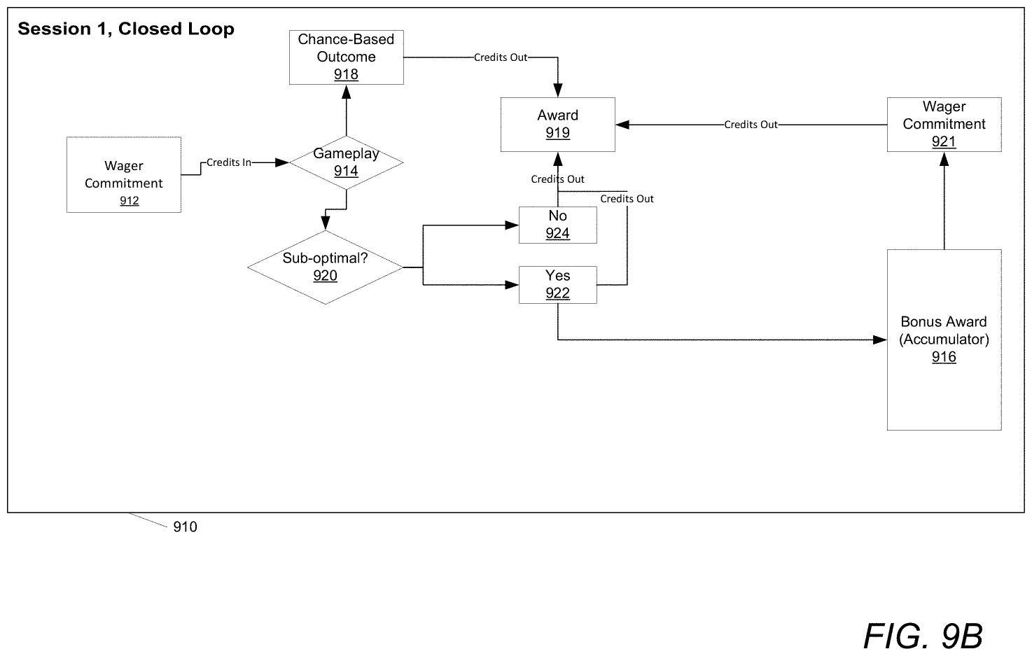

FIG. 9A is a block diagram of credit flows within a closed loop hybrid bonus interactive wagering system in accordance with various embodiments of the invention. In an embodiment, the hybrid bonus interactive wagering system provides an interactive application in the form of a hybrid bonus interactive wagering game having a skill-based game. A player plays the hybrid bonus interactive wagering game and a skill metric is determined for the player's skillful play of a skill-based game of the hybrid bonus interactive wagering game. In a closed loop embodiment, during a hybrid bonus interactive wagering session 908, the player's wager commitment 900, provides a commitment of credits to the hybrid bonus interactive wagering session during gameplay 902. A portion of the wagered credits are awarded 904 to the player as an award for winning individual wagers during the hybrid bonus interactive wagering session. In addition, a portion of the wagered credits are apportioned to a skill bonus award accumulator 906 based on the skill metric determined for the player's play where the amount of credits apportioned to the skill bonus award accumulator is inversely proportional to the skill metric determined for the player, that is, the higher the player's demonstrated skillful play, the fewer credits are apportioned to the skill bonus award accumulator and the lower the player's demonstrated skillful play, the more credits are apportioned to the skill bonus award accumulator. At various times during the hybrid bonus interactive wagering session, a bonus game is offered to the player. If the player wins the bonus game, a skill bonus award is awarded to the player using credits accumulated in the skill bonus award accumulator 906. In the example embodiment, the skill bonus award accumulator does not persist between hybrid bonus interactive wagering sessions. In a hybrid bonus interactive wagering session for a player, the player will be awarded credits out of a skill bonus award accumulator that is specific to that hybrid bonus interactive wagering session alone, there is no accumulation of skill bonus award credits between the hybrid bonus interactive wagering session and a subsequent hybrid bonus interactive wagering session, that is, a player is awarded a skill bonus award based on their own credits committed to the hybrid bonus interactive game and not based on credits contributed by other players in other hybrid bonus interactive wagering sessions.

FIG. 9B is another block diagram illustrating credit flows within a hybrid bonus interactive wagering system having a closed loop accommodating sub-optimal play in accordance with various embodiments of the invention.

As described herein, hybrid bonus interactive wagering utilizes system generated chance-based components and system detected player interactions with interactive objects of the system to generate a wagering outcome. In some embodiments of hybrid bonus interactive wagering, a wagering outcome includes both a skill-based interactive outcome component and a system generated chance-based outcome component, that is, the overall return to player (RTP) of the system is a combination of players' skill-based and chance-based outcomes. Through the use of the chance-based outcome component, a minimum (RTP) can be assured that is independent of players' skillful play while a portion of wagered credits are also awarded to the players based on the players' skillful play as determined by a skill metric of the skill-based interactive component. Optimal play occurs when players' skillful play results in players receiving all due skill-based outcomes and thus the actual RTP of the system is equal to the theoretical maximum RTP. Sub-optimal play occurs when players play less skillfully resulting in the players receiving less than all due skill-based outcomes and thus the actual RTP of the system is less than the theoretical maximum RTP.

In closed loop embodiments accommodating sub-optimal play during a hybrid bonus interactive wagering session 910 a player's wager commitment 912 provides a commitment of credits to the hybrid bonus interactive wagering session during gameplay 914.

A portion of the wagered credits are apportioned to a skill bonus award accumulator 916 based on a skill metric determined for each player's respective play where the amount of credits apportioned to the skill bonus award accumulator is inversely proportional to the respective skill metric determined for each player, that is, the higher the player's demonstrated skillful play, the fewer credits are apportioned to the skill bonus award accumulator and the lower the player's demonstrated skillful play, the more credits are apportioned to the skill bonus award accumulator. To do so, the system determines whether or not the player's skillful play was suboptimal 920 during the hybrid bonus interactive wagering session. If the player's skillful play was optimal 924, then the player is awarded 919 an amount of credits. If the player's skillful play was suboptimal 922, then the player is awarded 919 a lesser amount of credits.

At various times during the hybrid bonus interactive wagering session, a bonus game having a chance-based outcome 918 is provided to the player within the interactive hybrid bonus interactive wagering session. If the player wins the bonus game, a skill bonus award 919 is awarded to the player using credits 921 accumulated in the skill bonus award accumulator 906. In a first hybrid bonus interactive wagering session for a first player, the player will be awarded credits out of a skill bonus award accumulator that is specific to that hybrid bonus interactive wagering session alone, there is no accumulation of skill bonus award credits between the first hybrid bonus interactive wagering session and a second hybrid bonus interactive wagering session, that is, a player is awarded a skill bonus award based on their own credits committed to the interactive game and not based on credits contributed by other players in other hybrid bonus interactive wagering sessions.

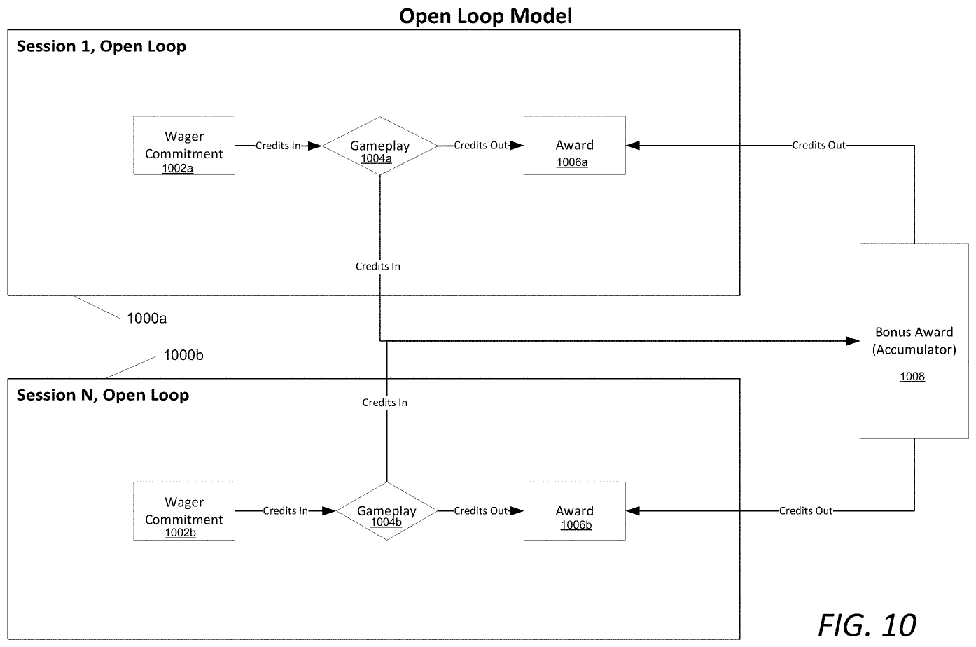

FIG. 10 is a block diagram of credit flows within an open loop hybrid bonus interactive wagering system in accordance with various embodiments of the invention. In an embodiment, a plurality of players play hybrid bonus interactive wagering games having a skill metric that is determined for each player's skillful play of a skill-based game of the hybrid bonus interactive wagering game. In the illustration, two hybrid bonus interactive wagering sessions are shown, 1000a and 1000b; however, it is to be understood that two or more hybrid bonus interactive wagering sessions would be accommodated. In open loop embodiments, each player's respective wager commitment, 1002a and 1002b, provides a commitment of credits to each player's respective hybrid bonus interactive wagering session during gameplay, 1004a and 1004b. A portion of the wagered credits are awarded 1006a and 1006b to each player respectively as an award for winning individual wagers during their respective hybrid bonus interactive wagering sessions. In addition, a portion of each player's wagered credits are apportioned to a skill bonus award accumulator 1008 based on a respective skill metric determined for each player's play where the amount of credits apportioned to the skill bonus award accumulator is inversely proportional to the skill metric determined for each player, that is, the higher a player's demonstrated skillful play, the fewer credits of the player's wager commitment are apportioned to the skill bonus award accumulator from that player, and the lower the player's demonstrated skillful play, the more credits of that player's wager commitment are apportioned to the skill bonus award accumulator. At various times during the hybrid bonus interactive wagering session, a bonus game is offered to each of the players. If a player wins the bonus game, a skill bonus award is awarded to that player using credits accumulated in the skill bonus award accumulator. In the example embodiment, the skill bonus award accumulator persists between hybrid bonus interactive wagering sessions. In a first session for a first player, the player will be awarded credits out of a skill bonus award accumulator that persists between sessions. In a subsequent hybrid bonus interactive wagering session, whether it initiated by the first player or a subsequent player, the player will be awarded credits out of the same skill bonus award accumulator that was associated with the first session.

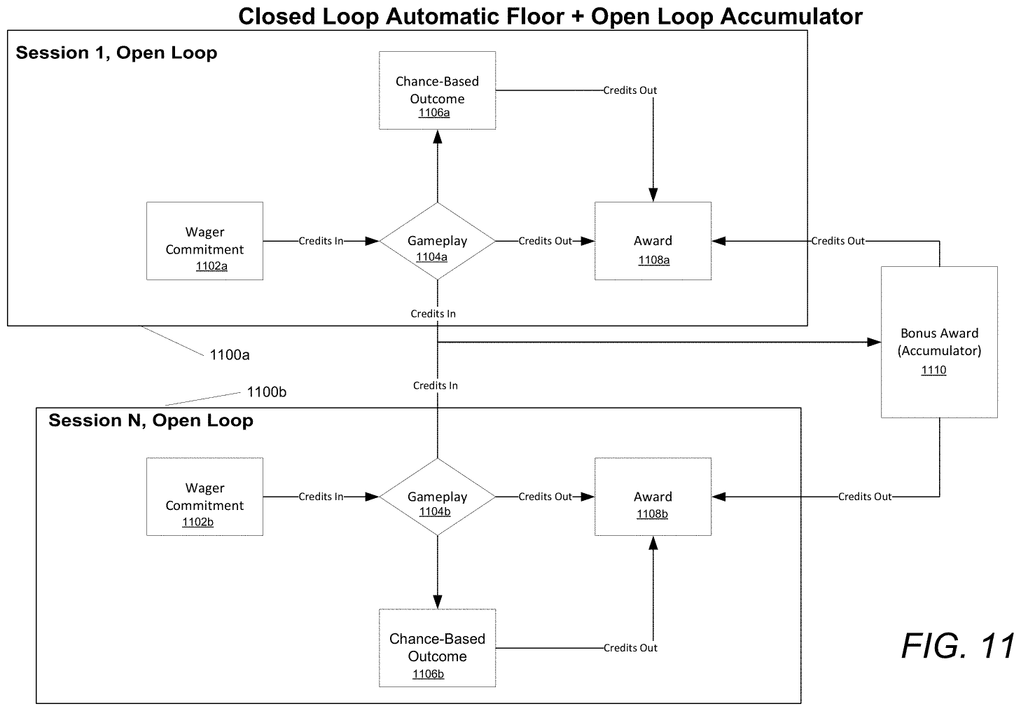

FIG. 11 is a block diagram of credit flows within a hybrid bonus interactive wagering system having both open and closed loops in accordance with various embodiments of the invention. In an embodiment, during two or more respective hybrid bonus interactive wagering sessions, such as hybrid bonus interactive wagering sessions 1100a and 1100b, a plurality of players play a hybrid bonus interactive wagering game having a skill metric that is determined for each player's skillful play of a skill-based game of the hybrid bonus interactive wagering game. In open loop embodiments, each player's wager commitment, 1102a and 1102b, provides a commitment of credits to each player's respective hybrid bonus interactive wagering session. During gameplay, 1104A and 1104b, portion of the wagered credits are awarded, 1108a and 1108b, to each player as an award for winning individual wagers during each player's respective hybrid bonus interactive wagering session. In addition, a portion of the wagered credits are apportioned to a skill bonus award accumulator 1110 based on the skill metric determined for each player's respective play where the amount of credits apportioned to the skill bonus award accumulator is inversely proportional to the skill metric determined for the player, that is, the higher the player's demonstrated skillful play, the fewer credits of the wager commitment are apportioned to the skill bonus award accumulator and the lower the player's demonstrated skillful play, the more credits of the wager commitment are apportioned to the skill bonus award accumulator. At various times during the hybrid bonus interactive wagering session, a bonus game having a chance-based outcome, 1106a and 1106b, is offered to the player within the interactive hybrid bonus interactive wagering session. If the player wins the bonus game, a chance-based outcome skill bonus award is awarded to the player using credits accumulated in the skill bonus award accumulator that persists between hybrid bonus interactive wagering sessions. In a first session for a first player, the player will be awarded credits out of a skill bonus award accumulator that persists between sessions. In a subsequent hybrid bonus interactive wagering session, whether it initiated by the first player or a subsequent player, the player will be awarded credits out of the same skill bonus award accumulator that was associated with the first session. Through the use of the chance-based outcome, a minimum return to player (RTP) can be assured that is independent of players' skillful play.

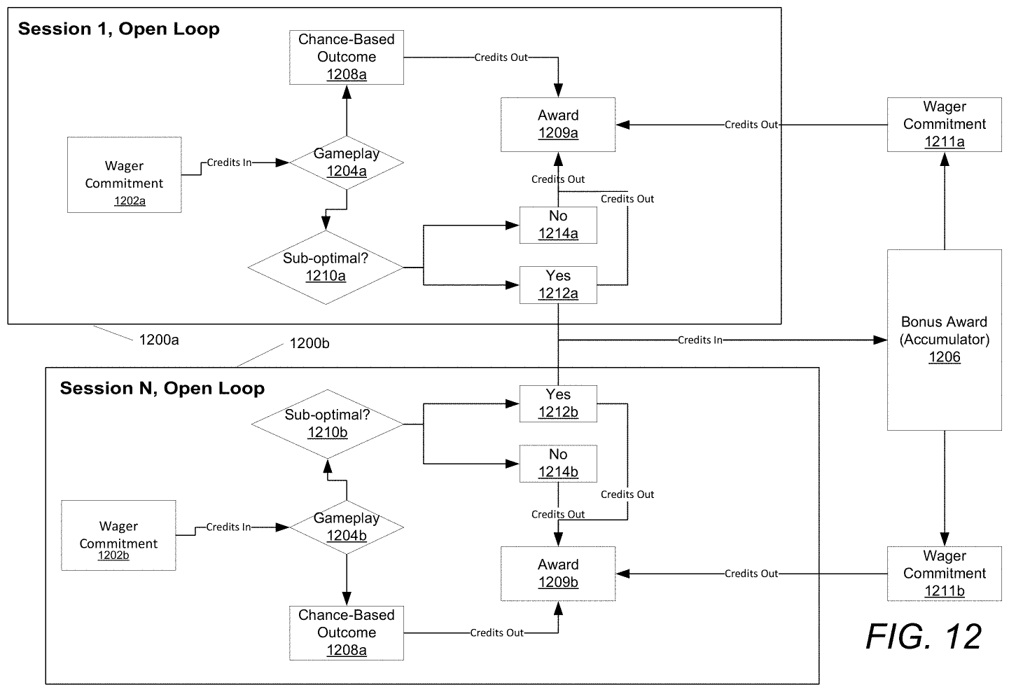

FIG. 12 is a block diagram of credit flows within a hybrid bonus interactive wagering system having both open and closed loops accommodating sub-optimal play in accordance with various embodiments of the invention. In open loop embodiments, during two or more hybrid bonus interactive wagering sessions such as hybrid bonus interactive wagering sessions 1200a and 1200b, each player's wager commitment, 1202a and 1202b, provides a commitment of credits to the hybrid bonus interactive wagering session during gameplay, 1204a and 1204b. A portion of the wagered credits are apportioned to a skill bonus award accumulator 1206 based on a skill metric determined for each player's respective play where the amount of credits apportioned to the skill bonus award accumulator is inversely proportional to the respective skill metric determined for each player, that is, the higher the player's demonstrated skillful play, the fewer credits are apportioned to the skill bonus award accumulator and the lower the player's demonstrated skillful play, the more credits are apportioned to the skill bonus award accumulator. At various times during the hybrid bonus interactive wagering session, a bonus game having a chance-based outcome, 1208a and 1208b, is offered to each respective player within the interactive hybrid bonus interactive wagering session. If a player wins the bonus game, a skill bonus award, 1209a and 1209b, is awarded to the player using credits, 1211a and 1211b, accumulated in the skill bonus award accumulator 1206 that persists between hybrid bonus interactive wagering sessions. In a first session for a first player, the first player will be awarded credits out of a skill bonus award accumulator that persists between sessions. In a subsequent hybrid bonus interactive wagering session, whether it initiated by the first player or a subsequent player, the player will be awarded credits out of the same skill bonus award accumulator that was associated with the first session. A portion of the wagered credits are also awarded to the player based on the player's skillful play as determined by the skill metric. A determination is made of whether or not the player's skillful play was suboptimal, 1210a and 1210b, during the hybrid bonus interactive wagering session. If the player's skillful play was optimal, 1212a and 1212b, then the player is awarded, 1209a and 1209b, an amount of credits. If the player's skillful play was suboptimal, 1214a and 1214b, then the player is awarded, 1209a and 1209b, a lesser amount of credits. Through the use of the chance-based outcome, a minimum return to player (RTP) can be assured that is independent of players' skillful play.

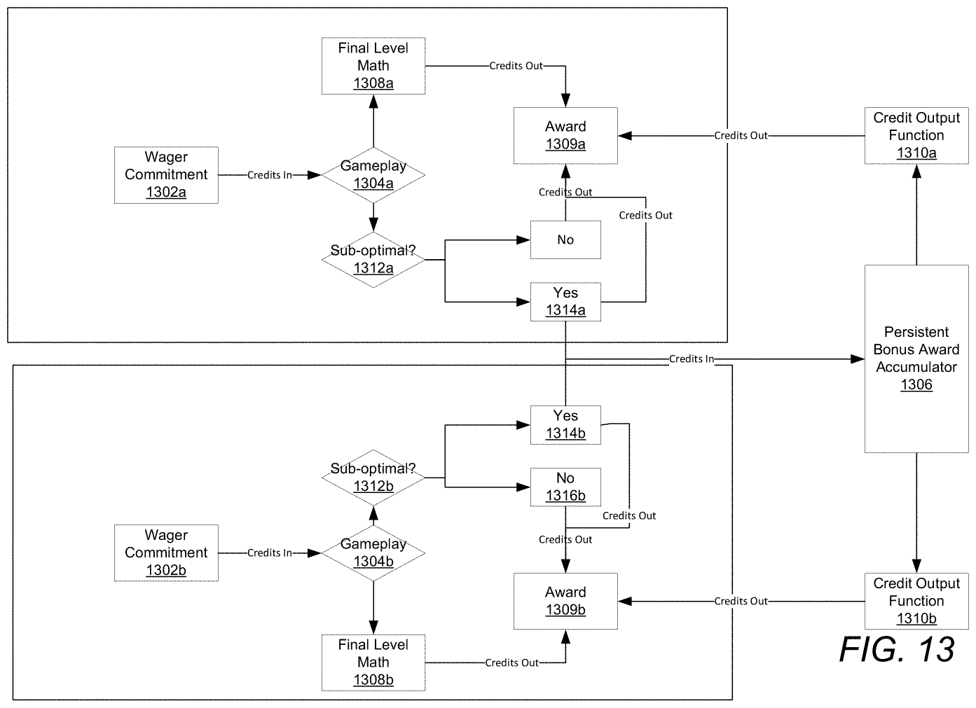

FIG. 13 is another block diagram of credit flows within a hybrid bonus interactive wagering system having both open and closed loops accommodating sub-optimal play in accordance with various embodiments of the invention. In the example embodiment, the hybrid bonus interactive wagering process includes a skill-based game having levels, that is, as a player engages in hybrid bonus interactive wagering, the player advances in a skill-based game having levels that represent more difficult game play opportunities to the player. During two or more hybrid bonus interactive wagering sessions, 1300a such as hybrid bonus interactive wagering sessions 1300a and 1300b, each respective player's wager commitment, 1302a and 1302b, during gameplay, 1304a and 1304b, provides a commitment of credits to the hybrid bonus interactive wagering session. A portion of the wagered credits are apportioned to a persistent skill bonus award accumulator 1306 based on a skill metric determined for each respective player's play where the amount of credits apportioned to the skill bonus award accumulator is inversely proportional to the skill metric determined for the player, that is, the higher the player's demonstrated skillful play, the fewer credits are apportioned to the skill bonus award accumulator and the lower the player's demonstrated skillful play, the more credits are apportioned to the skill bonus award accumulator. At a final level of the skill-based game, 1308a and 1308b, the player plays for a skill bonus award, 1309a and 1309b, that comes from the persistent skill bonus award accumulator 1306. If the player wins the final level game, a skill bonus award is awarded, 1309a and 1309b, to the player using credits accumulated in the persistent skill bonus award accumulator 1306 that persists between hybrid bonus interactive wagering sessions. Credits in the persistent skill bonus award accumulator 1306 are fed out in the bonus game through a modulating credit output function, 1310a and 1310b. In an example embodiments, the modulating output function is a payment of a fixed percentage of the current value of the credits in the skill bonus award accumulator

In a first session for a first player, the player will be awarded credits out of a skill bonus award accumulator that persists between sessions. In a subsequent hybrid bonus interactive wagering session, whether initiated by the first player or a subsequent player, the player will be awarded credits out of the same skill bonus award accumulator that was associated with the first session. A portion of the wagered credits are also awarded to the player based on the player's skillful play as determined by the skill metric. A determination is made of whether or not the player's skillful play was suboptimal, 1312a and 1312b, during the hybrid bonus interactive wagering session. If the player's skillful play was optimal, 1316a and 1316b, then the player is awarded an amount of credits. If the player's skillful play was suboptimal, 1314a and 1314b, then the player is awarded a lesser amount of credits. Through the use of the chance-based outcome, a minimum return to player (RTP) can be assured that is independent of players' skillful play.

In some embodiments, a multi-game progressive system is used to accumulate skill bonus award credits for two or more separate electronic gaming machines. In several embodiments, the progressive system offers players a chance at a final level/bonus game.

In various embodiments, funding for a bonus game comes in multiple parts: a first part is a floor RTP contribution in the underlying math that is a floor to provide a certain minimum level of award funding for the base game without requiring automatic feeding, a second part is an accumulating skill bonus award accumulator wherein feeding of the skill bonus award accumulator is non-automatic and occurs with sub-optimal play and in accordance with lost win potential. In an example embodiment, a percentage of a wager lost from not playing optimally is used to fund the skill bonus award accumulator. In another example embodiment, if the mid-skill RTP is 90%, the high-skill RTP is 95%, then when players exhibit mid-skill, the skill bonus award accumulator is incremented by 5% of the player's wager amount

In many embodiments, the accumulating skill bonus award accumulator persists across multiple play sessions. In an example embodiment, if a player feeds $10 into the skill bonus award accumulator in one session and does not clear out the skill bonus award accumulator, then a subsequent player may come along and potentially win that $10 in the skill bonus award accumulator.

In various embodiments, rewards from the accumulating skill bonus award accumulator are additive to the floor RTP of the math of a base hybrid bonus interactive wagering game.

In various embodiments, a closed loop credit bonus model is combined with an open loop credit bonus model.

In some embodiments, a non-automatic accumulation to fund a skill bonus award accumulator is provided while still being able to provide a floor value of RTP.

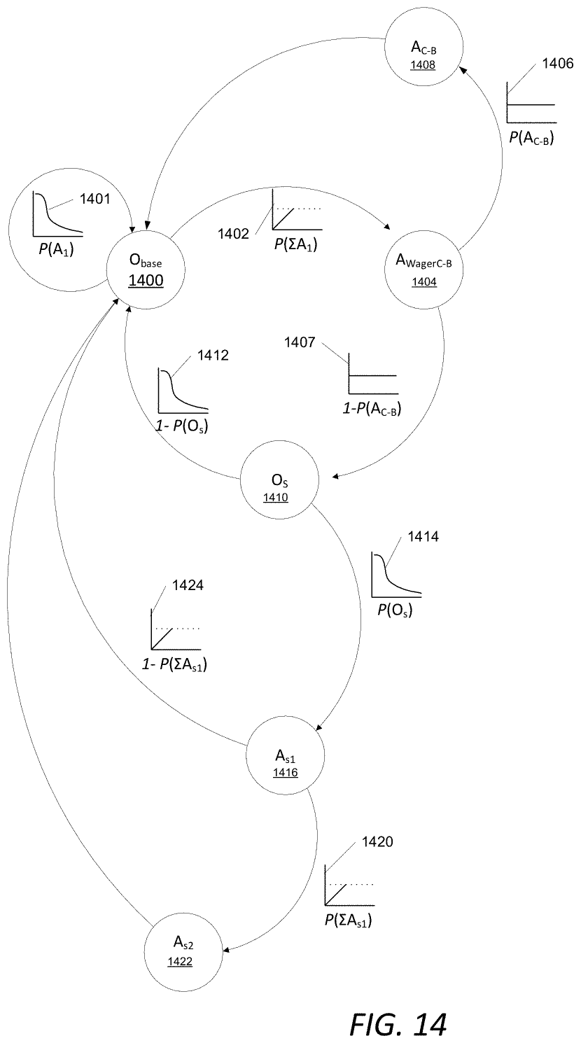

FIG. 14 is a state diagram of a process of a hybrid bonus interactive wagering system in accordance with various embodiments of the invention. In an base objective state Obase 1400 (interactive intermediate state), the system provides a skill-based game as a base game of a hybrid bonus interactive wagering game having one or more base objectives to a player during a hybrid bonus interactive wagering session. The player plays the hybrid bonus interactive wagering game and the system detects, with a probability of P(A1) 1041, the player's achievement of one or more of the base objectives of the skill-based game until a specified number of base objectives are achieved, that is, the number of achieved base objectives serves as a skill metric of the player's skillful play of the skill-based game. When the system detects that the specified number of base objectives have been achieved, the system transitions 1402 with a probability of Pak), 1402 to a chance-based wager achievement state AWagerC-B 1404 (system intermediate state) and the system executes a wager and generates a chance-based outcome for the wager as described herein.

If the chance-based outcome is greater than an amount of credits wagered in the chance-based wager, that is the wager results in a win for the player, the system transitions 1406 with a probability of P(A_{C-B}) to an award state AC-B 1408 (award state) where the player is awarded an amount of credits and the credit meters associated with the player are updated on the basis of the chance-based outcome as described herein. The system transitions back to the base objective state Obase 1400 (interactive intermediate state) and the player continues to play the skill-based game of the hybrid bonus interactive wagering game.

If the system determines that the chance-based outcome is less than an amount of credits wagered in the chance-based wager, that is the wager results in a loss for the player, the system transitions 1407 with a probability of 1−P(A_{C-B}) to a skill objective state Os 1410 (interactive intermediate state) where the player is presented with one or more additional skill objectives. If the system detects that the player fails to achieve the one or more additional skill objectives, the system transitions 1412 with a probability of 1−P(Oₛ) back to the base state Obase 1400 (interactive intermediate state) and the player continues to play the hybrid bonus interactive wagering game.

If the system detects that the player achieves the one or more additional skill objectives, the system transitions 1414 with a probability of P(Oₛ) to a first skill achievement state AS1 1416 (interactive intermediate state) and the system accumulates a count of achieved additional skill objectives. The accumulation of the amount of achieved additional skill objectives functions as a skill bonus award accumulator as such a count is analogous to tracking partial wins of credits that are not immediately awarded to the player, that is, a partial win is a win of an amount credits that is less than an amount of credits wagered.

If the system detects that a specified number of additional skill objectives are achieved, the system transitions 1420 with a probability of P(ΣAₛ₁) to a second skill achievement state AS2 1422 (award state), the system awards the player with a skill bonus award, and the system updates a credit meter associated with the player in accordance with the skill bonus award. The system transitions from state AS2 1422 to base state Obase 1400 (interactive intermediate state) and the player continues to play the hybrid bonus interactive wagering game.

If the system detects that the specified number of additional skill objectives are not achieved, the system transitions 1422 with a probability of 1−P(ΣAₛ₁) to base state Obase 1400 (interactive intermediate state) and the player continues to play the hybrid bonus interactive wagering game.

In some embodiments, the system executes a chance-based wager and generates a chance-based outcome as described herein and the system awards the chance-based outcome to the player as the skill bonus award.

In some embodiments, the system generates one or more additional skill objectives and presents the player with the one or more additional skill objectives. If the system detects that the player achieves the one or more additional skill objectives, the system awards the skill bonus award to the player.

In some embodiments, the system randomly determines a number of the additional skill objectives, that is the system generates a stochastic element and that stochastic element is used to determine the number of additional skill objectives presented to the player.

In some embodiments, the system generates a stochastic element that is a random value accorded to an additional skill-based objective, and the system accumulates the random value until the accumulation of the random value reaches a threshold value to determine if the system transitions to skill achievement state AS2 1422 and awards the player a skill bonus award.

In some embodiments, the accumulation of the amount of achieved additional skill objectives functioning as a skill bonus award accumulator is persistent, that is, in a first hybrid bonus interactive wagering session for a player, a player will be awarded a skill bonus award based on the amount of achieved additional skill objectives that persists between hybrid bonus interactive wagering sessions. In a subsequent hybrid bonus interactive wagering session, whether initiated by the first player or a subsequent player, a player will be awarded a skill bonus award based on the amount of achieved additional skill objectives that was associated with the previous hybrid bonus interactive wagering session as well as on an amount of achieved additional skill objectives associated with the subsequent hybrid bonus interactive wagering session as well, that is, a player is awarded a skill bonus award based on their own credits committed in their respective hybrid bonus interactive wagering session and based on credits committed by other players in other respective hybrid bonus interactive wagering sessions.

In some embodiments, the accumulation of the amount of achieved additional skill objectives functioning as a skill bonus award accumulator is not persistent, that is, in a hybrid bonus interactive wagering session for a player, the player will be awarded a skill bonus award based on the amount of achieved additional skill objectives that is specific to that hybrid bonus interactive wagering session alone, there is no accumulation of the amount of achieved additional skill objectives between a previous hybrid bonus interactive wagering session and a subsequent hybrid bonus interactive wagering session, that is, a player is awarded a skill bonus award based on their own credits committed in the hybrid bonus interactive wagering session and not based on credits committed by other players in other hybrid bonus interactive wagering sessions.

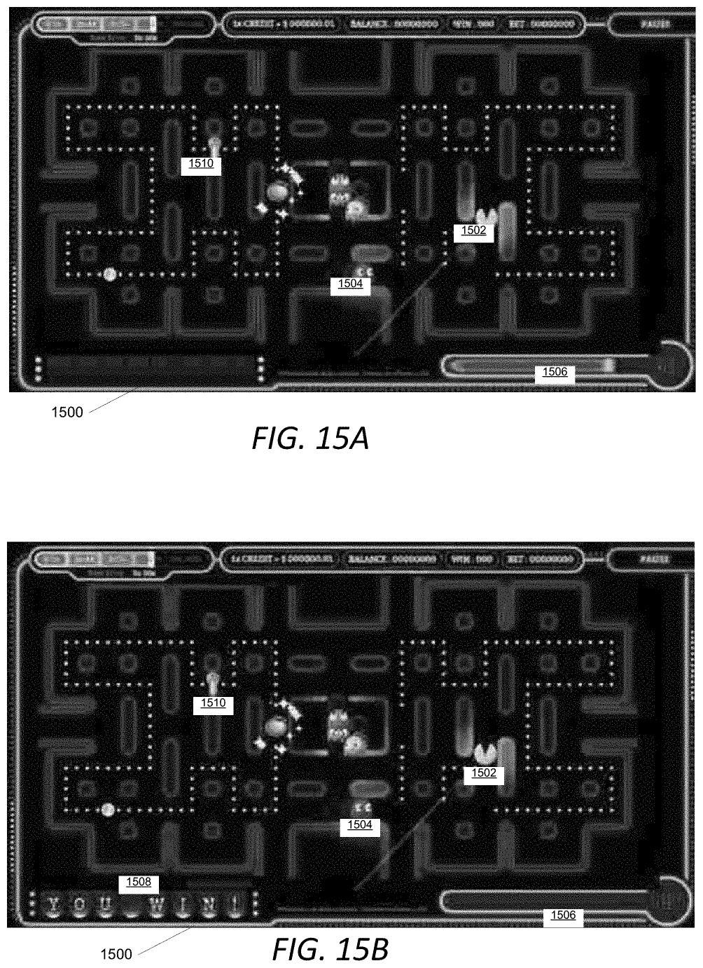

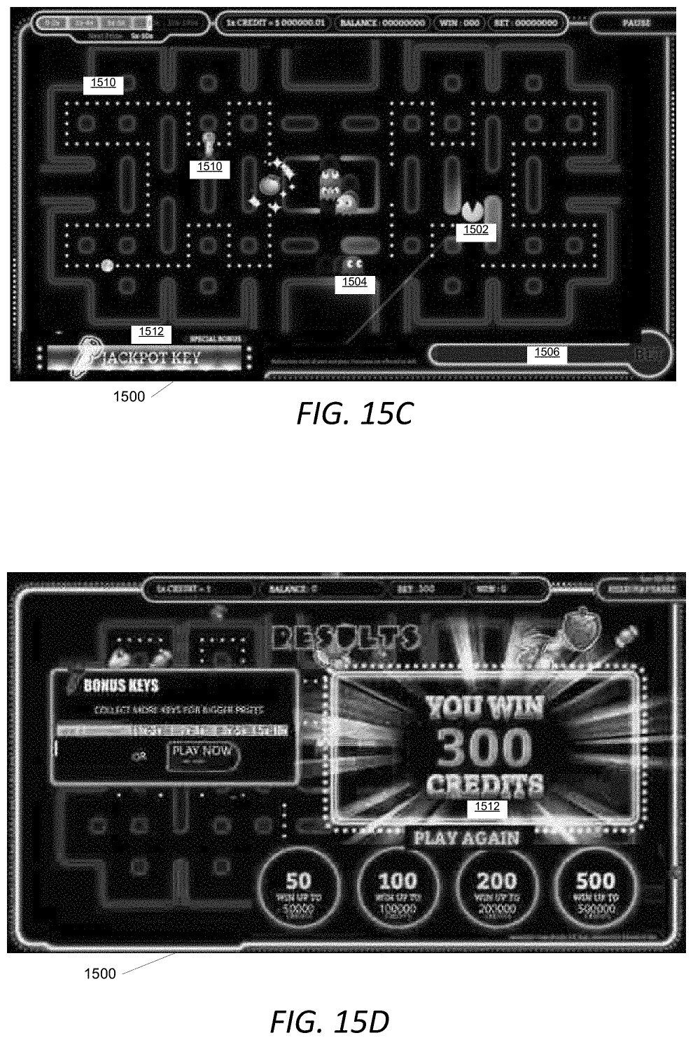

FIGS. 15A to 15D are illustrations of a user interface of a hybrid bonus interactive wagering system in accordance with various embodiments of the invention. Within FIGS. 15A to 15D, elements having the same reference numerals refer to the same element. Referring now to FIG. 15A, the user interface 1500 provides a skill-based game as a base game of a hybrid bonus interactive wagering game having one or more objectives to a player. An objective in the example embodiment is to collect dots using a player controlled avatar 1502 traveling through a maze while avoiding non-player characters, such as non-player character 1504. If a non-player character touches the player's avatar, the player's run is ended. The player plays the hybrid bonus interactive wagering game achieving objectives (collecting dots) of the hybrid bonus interactive wagering game until a specified number of objectives are achieved. An icon 1506 of the user interface fills up as the player collects the dots.

Referring now to FIG. 15B, when the specified number of objectives have been achieved, the system transitions to a chance-based wager achievement state and the system executes a chance-based wager and generates a chance-based outcome as described herein. If the chance-based outcome is greater than an amount of credits wagered in the chance-based wager, that is the wager results in a win for the player, the system transitions to an award state where the player is awarded an amount of credits and the credit meters associated with the player are updated on the basis of the chance-based outcome as described herein. The chance-based outcome is displayed to the player within the user interface 1510.

The system transitions back to the base objective state and the player continues to play the skill-based game of the hybrid bonus interactive wagering game. The icon 1506 indicating the amount of dots collected by the player is reinitialized and displayed to the player as being empty.

Referring now to FIG. 15C, if the chance-based outcome is less than an amount of credits wagered in the chance-based wager, that is the wager results in a loss for the player, the system transitions to a skill objective state where the player is presented with one or more additional skill objectives 1512. In the example embodiment, the additional skill objective includes having the player collect up keys 1510 that are spawned in the maze. If the player fails to achieve the one or more additional skill objectives, the system transitions back to the base state and the player continues to play the hybrid bonus interactive wagering game.

If the player achieves the one or more additional skill objectives, the system transitions to a first skill achievement state and the system accumulates a count of achieved additional skill objectives in the form of number of keys collected. Referring now to FIG. 15D, if a specified number of additional skill objectives are achieved as a number of keys collected, the system transitions to a second skill achievement state, the player is awarded a skill bonus 1512, and a credit meter associated with the player is updated in accordance with the skill bonus. The system transitions from the skill bonus award state back to the base state and the player continues to play the hybrid bonus interactive wagering game.

In some embodiments, the system executes a chance-based wager and generates a chance-based outcome as described herein and the chance-based outcome is awarded to the player as the skill bonus award.

In some embodiments, the player is presented with another skill-based objective of collecting fruit within the maze. If the player achieves the another skill-based objective by collecting the fruit, the player is awarded the skill bonus award.

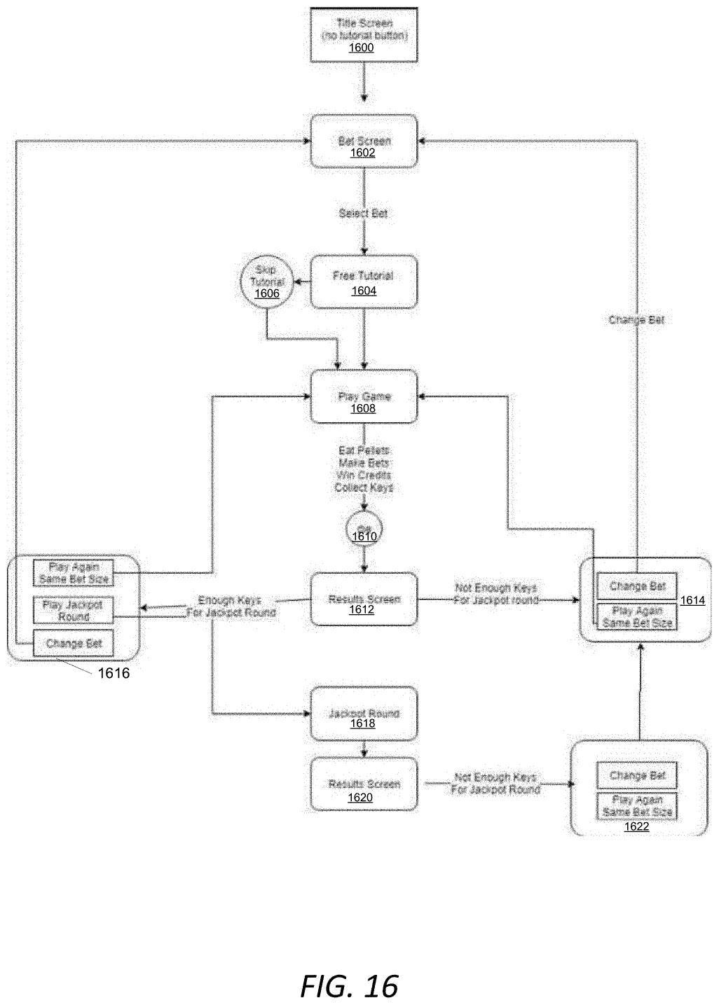

FIG. 16 is a flow chart of a process of a hybrid bonus interactive wagering system in accordance with various embodiments of the invention. During gameplay a player guides an avatar through a maze displayed on an interactive user display. The player's goal is to guide the avatar to eat dots (base objectives of an interactive intermediate state) in order to execute wagers (system intermediate state) to win a random amount of credits (chance-based outcome of an award state), and to find keys (additional objectives of an interactive intermediate state) to unlock a bonus or jackpot round (a system intermediate state) in which the player is awarded and amount of credits (chance-based outcome of an award state). The more keys the player finds, the more credits the player can win. During gameplay, the avatar is pursued by non-player avatars through the maze that will attempt to contact the player's avatar and cause the player's avatar to “die”.

Game Rules: Eat dots to fill a wager meter. When the player eats enough dots to fill the meter, a wager is run. If the player wins credits, the player's win will be displayed to the player. If the player doesn't win credits, one or more keys will appear on a map of the maze. The player collects keys to unlock the bonus or jackpot round. The more keys the player collects, the bigger the bonus or jackpot round prize.

Bonus or Jackpot Round Rules: Enter the bonus or jackpot round if the player has enough keys. In the bonus or jackpot round the player has a specified amount of time to collect as much fruit as possible (objectives of an interactive intermediate state). Each fruit is worth an amount of credits (chance-based outcome of an award state). Playing the bonus or jackpot round will spend the keys required to play. The player may have left over keys that stay in a progress bar displaying a number of keys collected.

Choosing a Wager Size: Players choose their wager size before being loaded into the maze. Each time the wager meter is filled, a wager will run to determine if a player has won credits or keys.

How To Bet: Players place a wager when they fill the bet-meter by eating dots. When the bet-meter is full, a wager is run at the size selected in the bet-selection screen.

Displaying a win: If a win is awarded by a random event, the flaps at the bottom left should display the win amount. If no credits are awarded, a key will be awarded. The key flies into the maze for collection.

Key Collection: Players run into a key to collect it. When a key is collected, the bonus or jackpot round meter at the top left should increase The amount of increase will be determined by a random event If a player dies before a key is collected, the keys are “gone”.

Bonus or Jackpot Round Meter (Magnification) The meter shows progress towards unlocking different bonus or jackpot round states The progress meter shows a “win up to” values.

When the game begins the wager meter is empty. When the game begins the win-flaps are empty.

As the player collects dots, the wager meter starts to fill up. When the wager meter is full, it is animated to announce the bet. When a wager is made, the flaps respond with an animation that delivers the chance-based outcome. When the player wins credits, the win amount should be shown on the bottom left. When the win amount is displayed, the wager meter will reset its progress. If credits are not won, the player will be awarded a skill bonus award or jackpot key. The bonus or jackpot key flies onto the maze and the player eats it to collect it. When the bonus or jackpot key is awarded, the wager meter is also reset in its progress. When a bonus or jackpot key is collected, a bonus or jackpot progress bar moves forward by an amount determined by a random component. The player may click “Play Now” to launch the bonus or jackpot round.

Bonus or Jackpot Round: Fruit in the bonus or jackpot round have static values. The process controller will inform the interactive controller how many fruit to deliver onto the maze as well as the value of the fruit.

User Experience: When a player decides to play the bonus or jackpot round they will spend a wager amount. In some embodiments, there is only one available wager size—the lowest-wager size available on the system.

Gameplay of Bonus or Jackpot Round: When the round starts, the player sees a timer counting down from a specified amount of time. The counter can live in the center of the maze. A large number of fruit appear on the screen. In some embodiments, the fruit values are generally low-value. When a fruit is eaten mid-game, a win-value is displayed. In some embodiments, the player's speed increased during the bonus or jackpot round.

In some embodiments, additional power-ups are provided near the player during the bonus or jackpot round.

In some embodiments: the player gets 30 seconds to collect as much fruit as possible; when the player eats a fruit a credit number flies off the fruit (won 1000 credits); there are ghosts or a timer that pressures the player to collect fast; after 30 seconds the player is eaten or collects everything.

In slightly more detail, the player is presented with a title screen 1600 and the player sets a bet using a bet screen 1602. The player is presented with an opportunity to play a free tutorial game 1604. The player may skip the tutorial 1606. The player plays the game 1608 and guides an avatar through a maze to eat pellets, makes bets, win credits, and collect keys. When the player's avatar is contacted by a non-player avatar, the player's avatar “dies” 1610 and the player is displayed a results screen 1612. If the player has not collected enough keys to enter the bonus or jackpot round, the player is displayed 1614 selectable options to change the player's bet size and/or play again using the same bet size. If the player has collected enough keys to play the bonus or jackpot round, the player is displayed selectable options 1616 to play again using the same bet size, chance their bet and play again, or play the bonus or jackpot round. If the player chooses to play the bonus or jackpot round, the player plays the bonus or jackpot round 1618 and collects fruit. At the end of the bonus or jackpot round, the player is displayed a results screen 1620 that displays the results of the bonus or jackpot round. If the player does not have enough remaining keys for another bonus or jackpot round, the player is displayed a screen having selections for changing a bet size and playing again playing again using the same bet size.

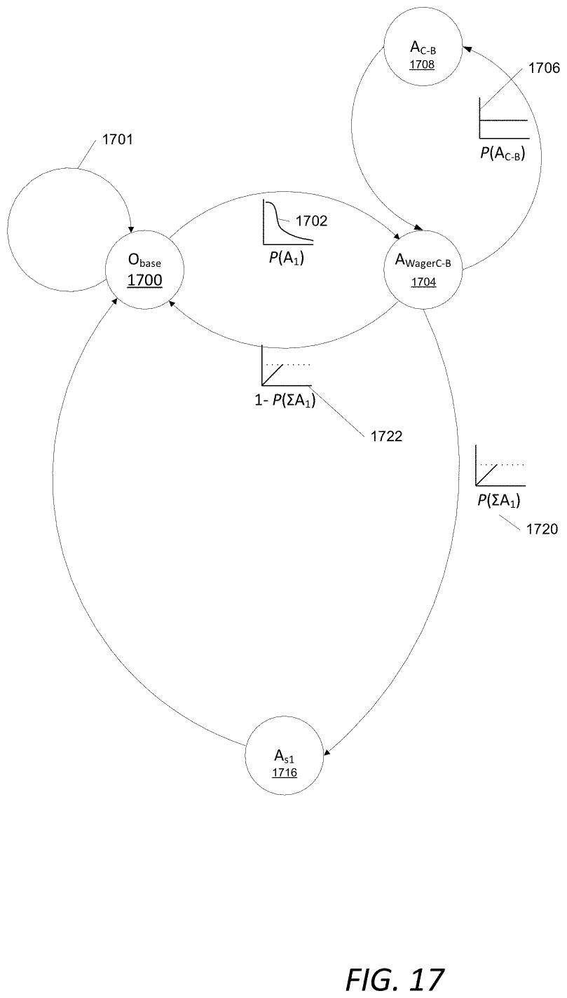

FIG. 17 is a state diagram of a process of a hybrid bonus interactive wagering system in accordance with various embodiments of the invention. In a base objective state 1700 (interactive intermediate state), the system provides a skill-based game as a base game of a hybrid bonus interactive wagering game having one or more base objectives (objectives of an interactive intermediate state) to a player. The player plays 1701 the hybrid bonus interactive wagering game. When the system detects a specified base objective has been achieved by the user, the system transitions 1702 with a probability of P(A₁) to a chance-based wager achievement state AWagerC-B 1704 (system intermediate state). The system executes a chance-based wager and generates a chance-based outcome as described herein. If the system determines that the chance-based outcome is a win for the player, that is the chance-based outcome is of an amount of credits greater than an amount of credits wagered, the system transitions 1706 with a probability of P(A_{C-B}) to an award state AC-B 1708 (award state) where the system awards the player with an amount of credits in accordance with the chance-based outcome (chance-based outcome of an award state) and updates one or more credit meters associated with the player are updated on the basis of the chance-based outcome as described herein. When the wager is executed, the system apportions a portion of the wager to a skill bonus award accumulator.

In addition, if the system determines that the player has achieved a specified number of bonus objectives, the system transitions 1720 with a probability of Pak) to a skill bonus award state 1716 and the system awards the player with a skill bonus award using credits accumulated in the skill bonus award accumulator and updates one or more credit meters associated with the player in accordance with the skill bonus award, that is, the number of achieved base objectives serves as a skill metric of the player's skillful play of the base skill-based game and that skill metric is used to award the player an award of credits from the credits accumulated in the skill bonus award accumulator. The system transitions back to the base objective state Obase 1700 (interactive intermediate state) and the player continues to play the skill-based game of the hybrid bonus interactive wagering game.

If the system detects that the player has not achieved the specified number of base objectives, the system transitions 1722 with a probability of 1−P(ΣA₁) to the base objective state Obase 1700 (interactive intermediate state) and the player continues to play the skill-based game of the hybrid bonus interactive wagering game.

In some embodiments, the system executes a chance-based wager and generates a chance-based outcome as described herein and the system awards the chance-based outcome to the player as the skill bonus award.

In some embodiments, the skill bonus award accumulator is persistent, that is, in a first hybrid bonus interactive wagering session for a player, a player will be awarded a skill bonus award based on the amount of credits of the skill bonus award accumulator that persists between hybrid bonus interactive wagering sessions. In a subsequent hybrid bonus interactive wagering session, whether initiated by the first player or a subsequent player, a player will be awarded a skill bonus award based on the amount of credits of the skill bonus award accumulator that was associated with the previous hybrid bonus interactive wagering session as well as on an amount of amount of credits of the skill bonus award accumulator associated with the subsequent hybrid bonus interactive wagering session as well, that is, a player is awarded a skill bonus award based on their own credits committed in their respective hybrid bonus interactive wagering session and based on credits committed by other players in other respective hybrid bonus interactive wagering sessions.

In some embodiments, the skill bonus award accumulator is not persistent, that is, in a hybrid bonus interactive wagering session for a player, the player will be awarded a skill bonus award based on the amount of credits of the skill bonus award accumulator that is specific to that hybrid bonus interactive wagering session alone, there is no accumulation of the amount of credits of the skill bonus award accumulator between a previous hybrid bonus interactive wagering session and a subsequent hybrid bonus interactive wagering session, that is, a player is awarded a skill bonus award based on their own credits committed in the hybrid bonus interactive wagering session and not based on credits committed by other players in other hybrid bonus interactive wagering sessions.

In some embodiments, the system pre-calculates a chance-based outcome that is associated with a specified objective by executing a chance-based wager and storing the chance-based outcome in a temporary memory store. When the system detects that the specified objective has been achieved and the system transitions 1702 to a chance-based wager achievement state AWagerC-B 1704, the system awards to the player the chance-based outcome of the previously executed chance-based wager. If the system does not detect achievement of the specified objective within a specified period of time, the system credits to the skill bonus award accumulator the chance-based outcome of the previously executed chance-based wager.

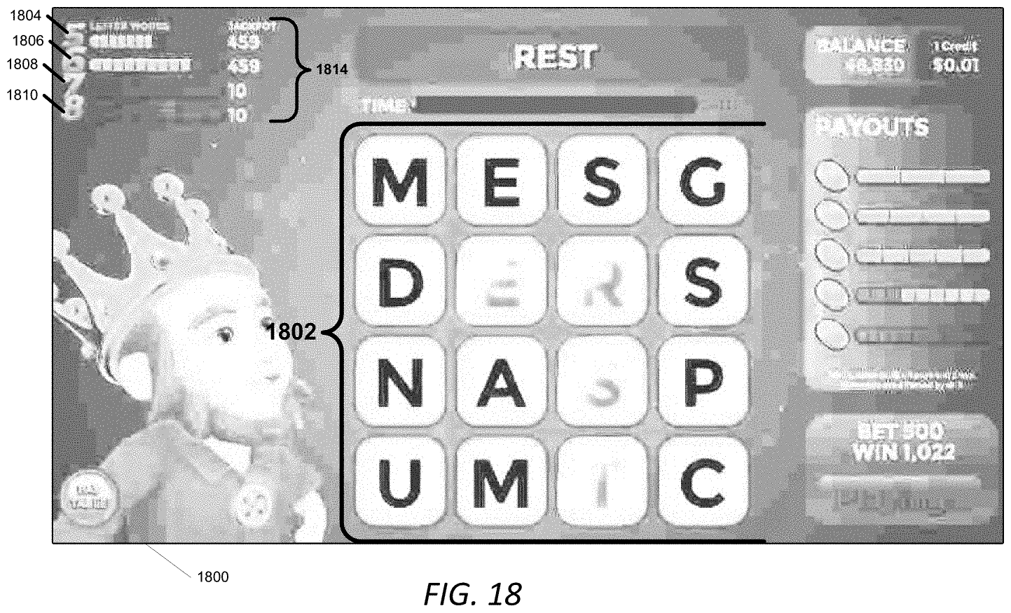

FIG. 18 illustrates a user interface 1800 of a hybrid bonus interactive wagering system in accordance with various embodiments of the invention. While playing a word finding skill-based game 1802 of a hybrid bonus interactive wagering game, a player may collect skill bonus awards by accomplishing various objectives that require skillful play. In an embodiment, specified objectives include: forming 15 5-letter words 1804; forming 12 6-letter words 1806; forming 9 7-letter words 1808; and forming 6 8-letter words 1810. Each of these objectives is displayed associated with a current skill jackpot or skill bonus award value 1814 and a progress bar 1814. Every wager executed increases the amount of each skill bonus award by a percentage of the wager executed. In various embodiments, the skill bonus awards are independent of one another. In some embodiments, specified objectives achieved (e.g. forming a 7-letter word) increase the corresponding progress-bar only. A skill bonus award is awarded when the specified objective achievements have been met, and the corresponding progress-bar is full. In various embodiments, collecting one skill bonus award doesn't affect the progress or accumulated value of other skill bonus awards. In various embodiments, more than one skill bonus award can be awarded in a game session/game round.

In some embodiments, eligibility for skill bonus awards requires a player to commit wagers at certain wager amounts. In an example embodiment, a lowest wager amount commitment doesn't qualify the player for skill bonus awards. During such wagers, the progress bars are disabled and the player's action don't contribute to progress towards any of the skill bonus awards. A highest wager commitment amount makes the player eligible for the entire accumulated amount in each skill bonus award. Wager commitment amounts between the highest and the lowest qualify the player for a prorated portion of each skill bonus award.

When a player achieves the specified skill objective, the system awards a skill bonus award to the player who collects the associated skill bonus award and the skill bonus award's progress bar is reset. In some embodiments, the skill bonus award's value resets to zero if the player was awarded a skill bonus award while committing wagers at a maximum wager commitment amount or a prorated remainder value if the player was awarded a skill bonus award while playing at a wager amount between highest and lowest wager commitment amounts.

In various embodiments, when a player cashes out (ends the hybrid bonus interactive wagering session) all progress bars are reset, and progress they have made will be lost; however, all skill bonus award values remain unchanged, and keep growing with each subsequent wager, that is the skill bonus award accumulator is persistent as described herein. In various embodiments, an operator of the system can seed the skill bonus awards.

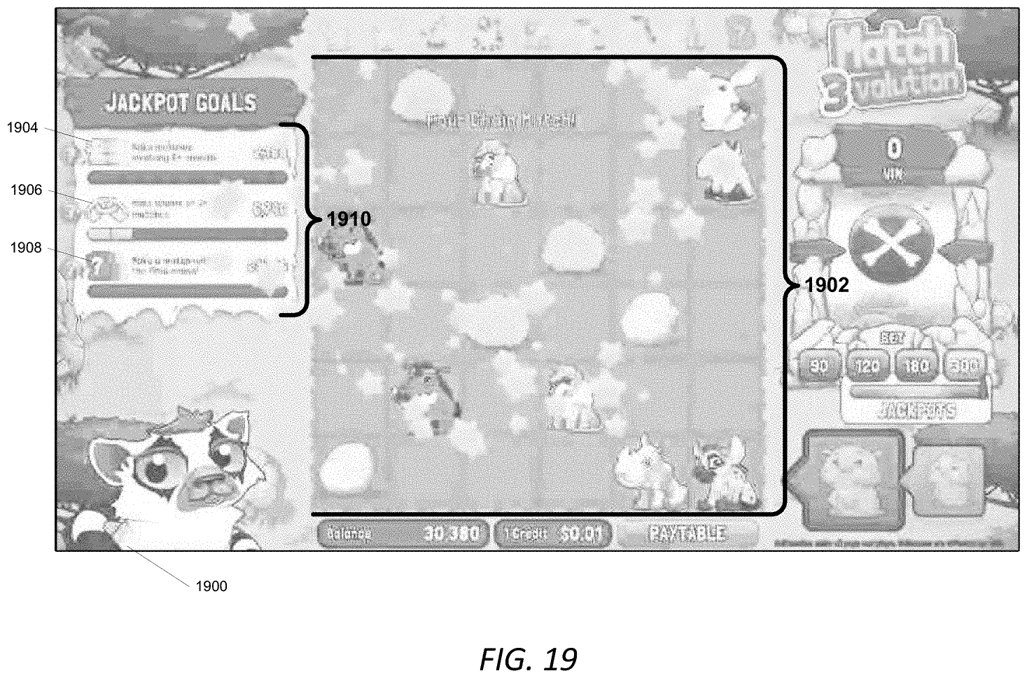

FIG. 19 illustrates a user interface 1900 of a hybrid bonus interactive wagering system in accordance with various embodiments of the invention. While playing a match three skill-based game 1902 of a hybrid bonus interactive wagering game, a player may collect skill bonus awards by accomplishing various objectives that require skillful play. In an embodiment, specified objectives include: making 12 matches that involve 6 or more animals each 1904; making 9 chains of 3 or more matches 1906; and making a match a final animal symbol 1908.

Each of these objectives is associated with a skill bonus award value, and a progress bar 1910. Every wager executed increases the amount of each skill bonus award by a percentage of the wager executed. In various embodiments, the skill bonus awards are independent of one another. In some embodiments, specified objectives achieved (e.g. making a 3 chain match) increase the corresponding progress-bar only. A skill bonus award is awarded when the specified objective achievements have been met, and the corresponding progress-bar is full. In various embodiments, collecting one skill bonus award doesn't affect the progress or accumulated value of other skill bonus awards. In various embodiments, more than one skill bonus award can be awarded in an interactive gaming session/game round.

In some embodiments, eligibility for skill bonus awards requires a player to commit wagers at certain wager amounts. In an example embodiment, a lowest wager amount commitment doesn't qualify the player for skill bonus awards. During such wagers, the progress bars are disabled, and the player's action don't contribute to progress towards any of the skill bonus awards. A highest wager commitment amount makes the player eligible for the entire accumulated amount in each skill bonus award. Wager commitment amounts between the highest and the lowest qualify the player for a prorated portion of each skill bonus award.

When a player achieves the specified skill objective, the system awards a skill bonus award to the player who collects the associated skill bonus award and the skill bonus award's progress bar is reset. In some embodiments, the skill bonus award's value resets to zero if the player was awarded a skill bonus award while committing wagers at a maximum wager commitment amount or a prorated remainder value if the player was awarded a skill bonus award while playing at a wager amount between highest and lowest wager commitment amounts.

In various embodiments, when a player cashes out (ends the hybrid bonus interactive wagering session) all progress bars are reset, and progress they have made will be lost; however, all skill bonus award values remain unchanged, and keep growing with each subsequent wager, that is skill bonus award accumulators are persistent as described herein. In various embodiments, an operator of the system can seed the skill bonus awards.

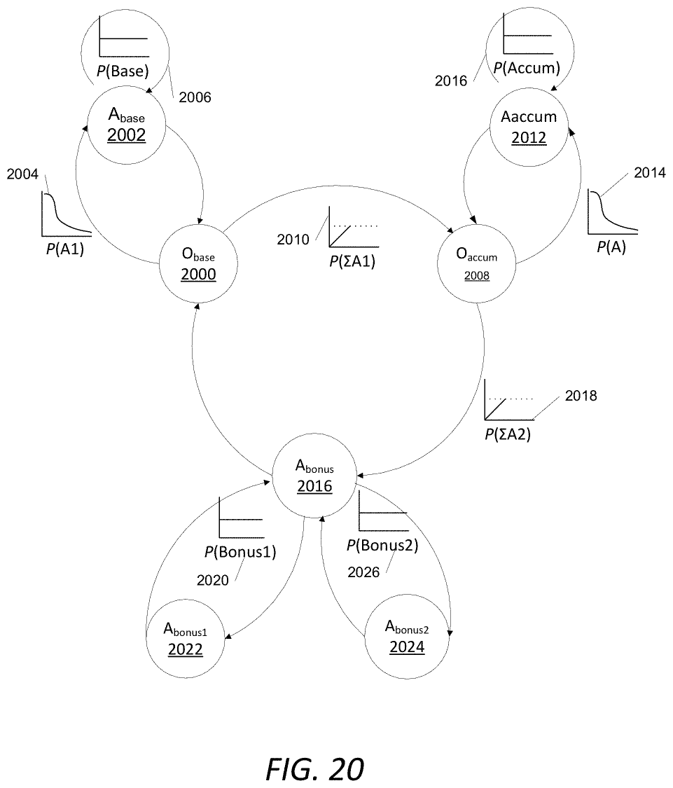

FIG. 20 is a state diagram of another process of a process of a hybrid bonus interactive wagering system in accordance with various embodiments of the invention. During a hybrid bonus interactive wagering process, the system presents an objective of a skill-based game to a player in a base objective state Obase 2000. Each time the system detects that the player achieves the objective (interactive stochastic event), the system transitions to a base award state Abase 2002 with a probability of P(A1) 2004. The system executes a chance-based wager having a chance-based outcome (system stochastic event) that has a first expected value (EV1) in accordance with a probability of P(Base) 2006. The system awards an amount of credits to the player based on the chance-based outcome. The system transitions back to the base state Obase 2000.

When the system detects that the player has achieved a specified objective (interactive stochastic event) in the skill-based interactive game, the system transitions to a bonus accumulation state Oaccum 2008 with a probability of P(SigmaA1) 2010. In state Oaccum 2008, if the system detects an achievement of an objective (interactive stochastic event) by the player, the system transitions with probability of P(A2) 2014 to an accumulation award state Aaccum 2012 where the system executes a wager having a chance-based outcome (system stochastic event) that has a second expected value (EV2) in accordance with a probability of P(Accum) 2016 where EV2 is less than EV1. The system awards an award of an amount of credits to the player based on the chance-based outcome. In addition, the system allocates an amount of credits to a skill bonus award accumulator. In some embodiments, the amount of credit allocated to the skill bonus award accumulator is determined based on a difference between EV1 and EV2 and an amount of credits committed to the wager. In an example embodiment, if EV1 is 70 credits and EV2 is 20 credits for a wager of 100 credits, then 50/100 credits or 5 credits of a 100 credit wager are allocated to the skill bonus award accumulator.

When the system detects that the player has achieved a specified objective (interactive stochastic event) in the skill-based interactive game, the system transitions to a skill bonus award state Abonus 2016 with a probability of P(SigmaA2) 2018. In state Abonus 2016, the system executes a wager having a first bonus chance-based outcome (system stochastic event) and the system transitions to skill bonus award state Abonus1 2022 in accordance with a probability of P(Bonus1) 2020 and the system awards an amount of credits to the player as skill bonus award. In addition, the system executes a wager having a second bonus chance-based outcome (system stochastic event) and transitions to skill bonus award state Abonus2 2024 in accordance with a probability of P(Bonus2) 2026 wherein the system allocates an amount of credits for the second bonus chance-based outcome from the skill bonus award accumulator and an award of that amount of credits is awarded to the player as a skill bonus award based on the second bonus chance-based outcome. The system transitions back to state Obase 2000 and the player continues to play the hybrid bonus interactive wagering game.

In some embodiments, the skill bonus award accumulator is persistent, that is, in a first hybrid bonus interactive wagering session for a player, a player will be awarded a skill bonus award based on the amount of credits of the skill bonus award accumulator that persists between hybrid bonus interactive wagering sessions. In a subsequent hybrid bonus interactive wagering session, whether initiated by the first player or a subsequent player, a player will be awarded a skill bonus award based on the amount of credits of the skill bonus award accumulator that was associated with the previous hybrid bonus interactive wagering session as well as on an amount of amount of credits of the skill bonus award accumulator associated with the subsequent hybrid bonus interactive wagering session as well, that is, a player is awarded a skill bonus award based on their own credits committed in their respective hybrid bonus interactive wagering session and based on credits committed by other players in other respective hybrid bonus interactive wagering sessions.

In some embodiments, the skill bonus award accumulator is not persistent, that is, in a hybrid bonus interactive wagering session for a player, the player will be awarded a skill bonus award based on the amount of credits of the skill bonus award accumulator that is specific to that hybrid bonus interactive wagering session alone, there is no accumulation of the amount of credits of the skill bonus award accumulator between a previous hybrid bonus interactive wagering session and a subsequent hybrid bonus interactive wagering session, that is, a player is awarded a skill bonus award based on their own credits committed in the hybrid bonus interactive wagering session and not based on credits committed by other players in other hybrid bonus interactive wagering sessions.

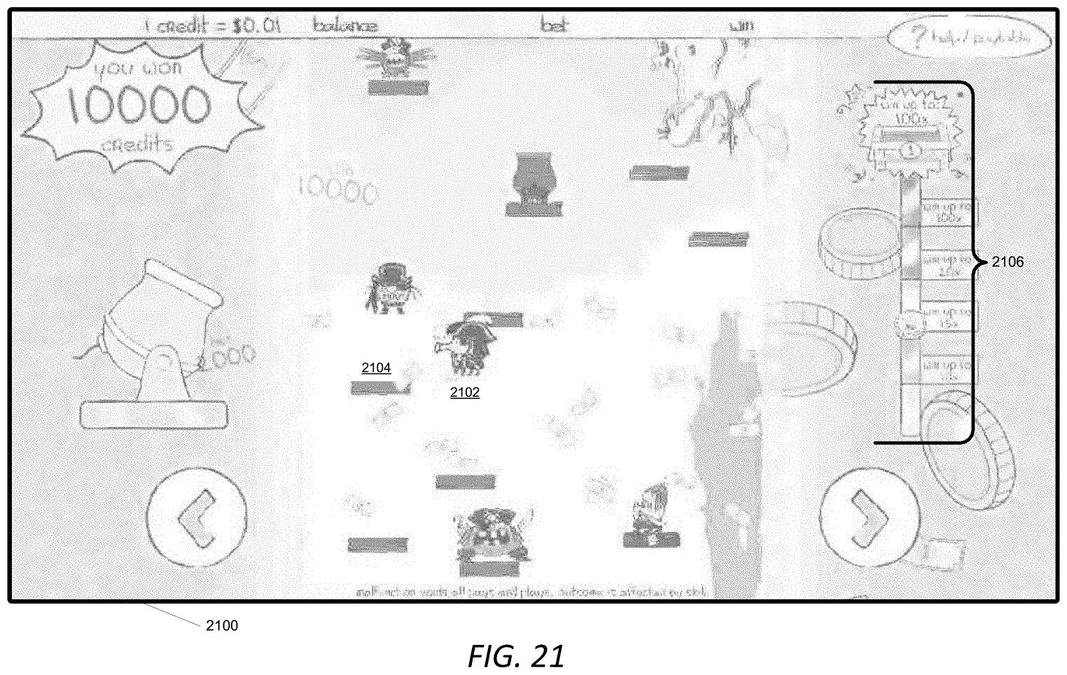

FIG. 21 is another illustration of a user interface 2100 of a skill-based interactive game of a hybrid bonus interactive wagering system in accordance with various embodiments of the invention. The skill-based interactive game is a two-dimensional platform style game wherein a player guides an avatar 2102 to land on a series of platforms (objectives), such as platform 2104. As the system detects that the player has guided the avatar to land on each platform (achievement of the objective), the system executes a wager and generates one or more chance-based outcomes as described herein. As the player progresses during an interactive gaming session, the player advances toward one or more specified objectives as indicated by the indicator on the right-hand portion of the user interface 2106. When the system detects that the player achieves a specified objective, the system starts to accumulate amounts of credits in a skill bonus award accumulator as described herein. When the system detects that the player achieves the penultimate objective, the system executes a bonus wager wherein the player is awarded a skill bonus award of an amount of credits of a chance-based outcome and a skill bonus award of an amount of credits based on a chance-based outcome and an amount of credits available in the skill bonus award accumulator.

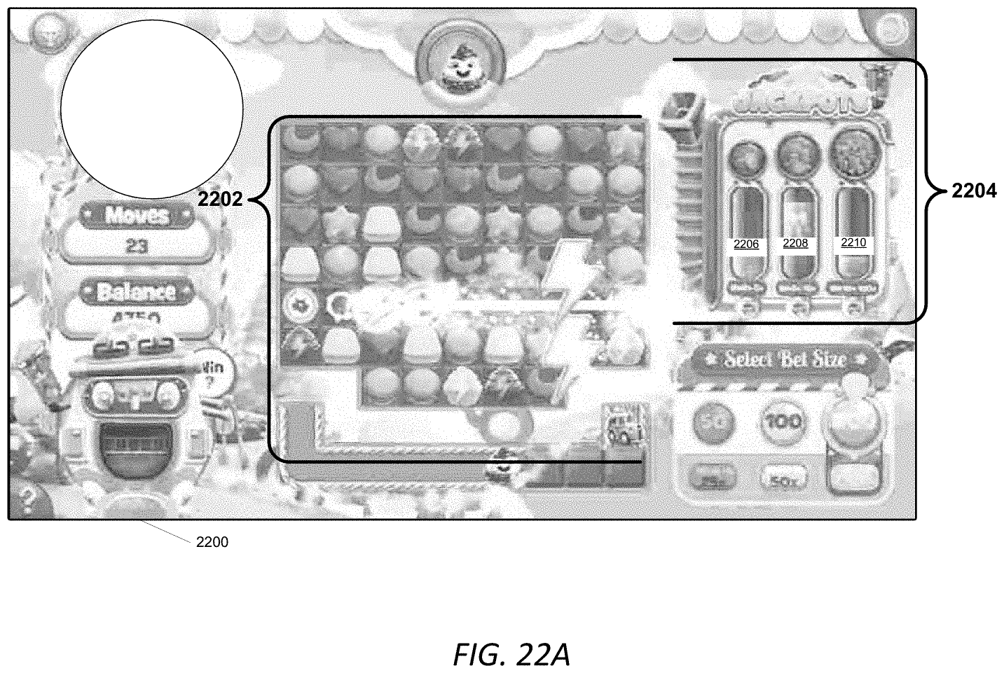

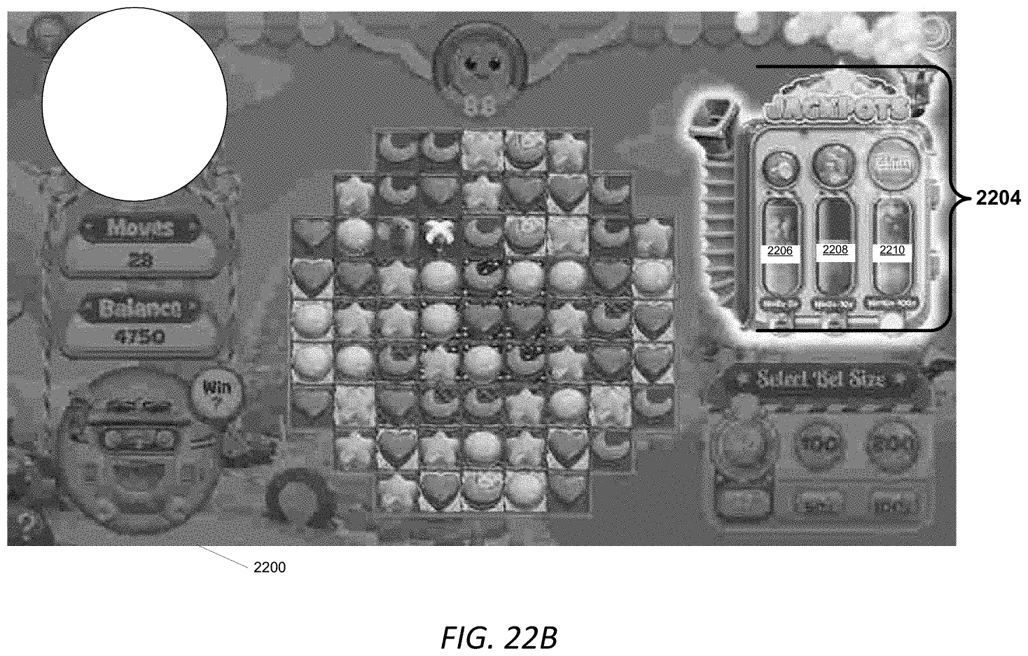

FIGS. 22A and 22B are illustrations of another user interface of a skill-based interactive game of a hybrid bonus interactive wagering system in accordance with various embodiments of the invention. In FIGS. 22A and 22B, elements of each figure having the same reference numerals correspond to the same element. Referring now to FIG. 22A, the skill-based interactive game is a matching game wherein a player moves game objects within a 2-dimensional grid structure 2202 in order to match 3-or-more game objects together to remove them from the grid (objective). Each time the system detects that a successful match is made (achievement of the objective), the system executes a wager and generates a chance-based outcome. The chance-based outcome of the wager is either a win for the player, that is an amount of credits are awarded to the player that are greater than an amount of credits wagered, or an amount of progress toward an objective of making a wager in a “bonus or jackpot round” wherein a chance-based outcome is generated and an award of credits is awarded to the player.

Referring now to FIG. 22B, progress toward the objective is shown to the player in the user interface in two or more progress indicators 2204, such as progress indicators 2206, 2208, and 2210, with each progress indicator representative of a respective objective of the system executing a wager having a specified minimum and maximum chance-based outcome of a skill bonus award that is greater than an amount of credits wagered, that is, the skill bonus award is an actual win wherein an amount of credits awarded is greater than an amount of credits wagered. In an example embodiment, a skill bonus award is at least 2 times an amount of credits wagered and up to 5 times the amount of credits wagered, another skill bonus award is at least 3 times the amount of credits wagered and up to 10 times the amount of credits wagered, and yet another skill bonus award is at least 10 times the amount of credits wagered and up to 100 times the amount of credits wagered. As the player progresses, the player advances toward the one or more specified objectives as indicated by the progress indicators on the right-hand portion of the user interface.

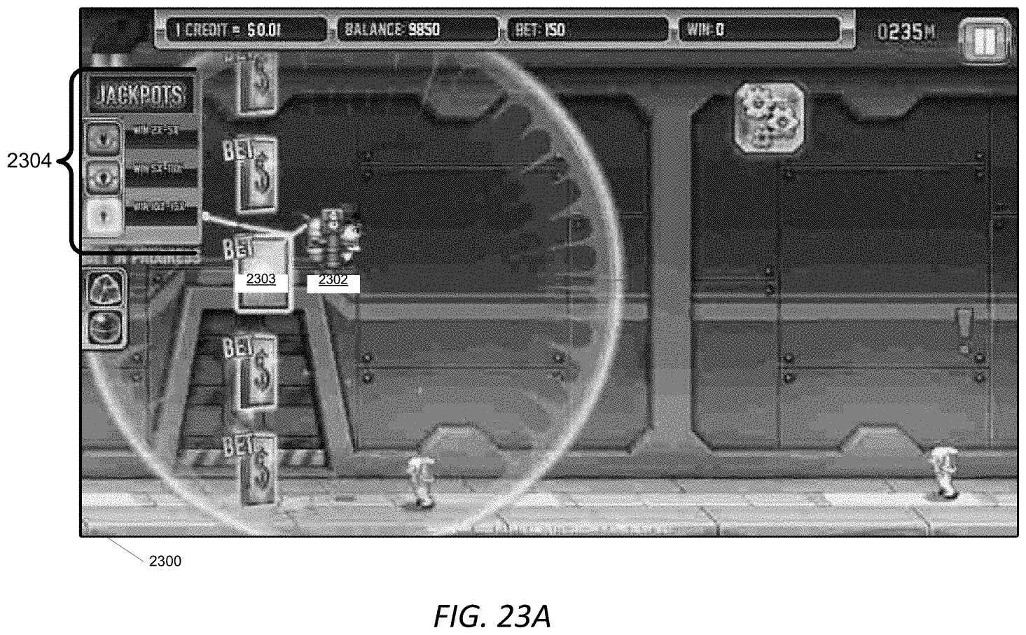

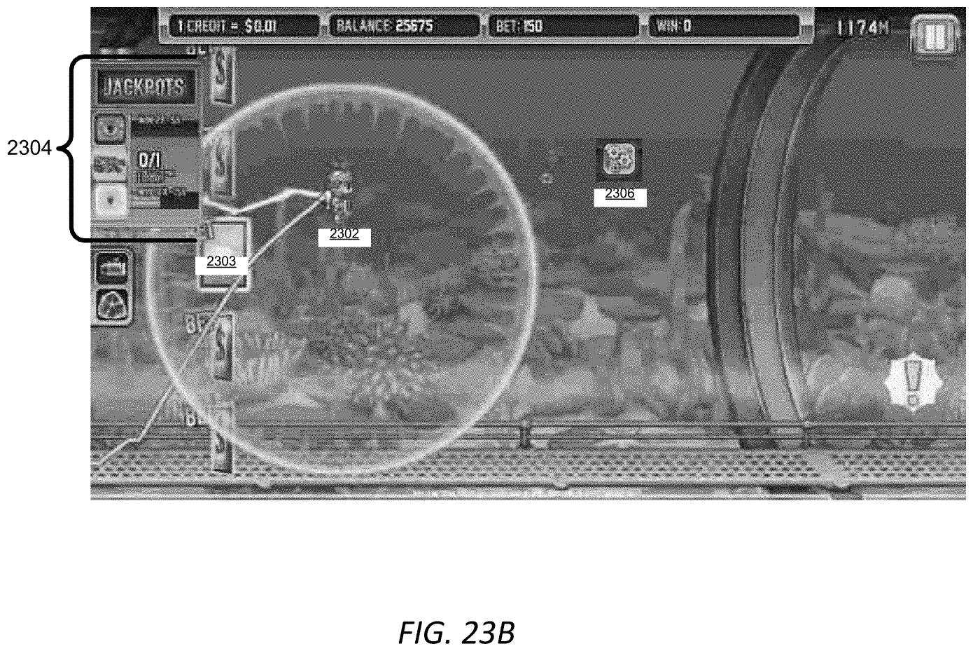

FIGS. 23A and 23B are illustrations of another user interface 2300 of a skill-based interactive game of a hybrid bonus interactive wagering system in accordance with various embodiments of the invention. In FIGS. 23A and 23B, elements of each figure having the same reference numerals correspond to the same element. The skill-based interactive game is a side-scrolling runner style game where the player attempts to navigate a player character 2302 above and below randomly generated game objects that are obstacles. At specified points within the game map, the player will encounter game objects (objectives) 2303 that when the system detects that the player interacts with the game objects (achievement of the objectives), the system will execute wagers to generate chance-based outcomes as awards of amounts of credits that the system awards to the player. The outcome of the wager is either: a win for the player, that is an amount of credits are awarded to the player that are greater than an amount of credits wagered; or an amount of progress toward an objective of making a wager in a “bonus or jackpot round” wherein a chance-based outcome is generated and an award of credits is awarded to the player. Progress toward the objective is shown to the player in the user interface in two or more progress indicators 2304, with each progress indicator representative of a respective objective of making a wager having a specified minimum and maximum outcome that is greater than the amount wagered. As the player progresses, the player advances toward one or more specified objectives as indicated by the progress indicators 2304 on the left-hand portion of the user interface. Each progress indicator is representative of a respective objective of the system executing a wager having a specified minimum and maximum chance-based outcome of a skill bonus award that is greater than an amount of credits wagered, that is, the skill bonus award is an actual win wherein an amount of credits awarded is greater than an amount of credits wagered. In an example embodiment, a skill bonus award is at least 2 times an amount of credits wagered and up to 5 times the amount of credits wagered, another skill bonus award is at least 3 times the amount of credits wagered and up to 10 times the amount of credits wagered, and yet another skill bonus award is at least 10 times the amount of credits wagered and up to 15 times the amount of credits wagered.

Referring now to FIG. 23B, once the player is eligible to make the bonus or jackpot wager, an additional bonus or jackpot objective 2306 is generated for the player in the form of an additional objective that the player must achieve in order to actually make the wager for the bonus or jackpot round. In an embodiment, the objective is for the player to collect a specific power-up.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. An electronic gaming machine for performing a hybrid bonus interactive wagering process, comprising:
an interactive controller constructed to:
generate an interactive user interface including interactive elements;
detect player interactions of a player with the interactive elements of the interactive user interface to determine achievement of a base objective;
determine an interactive intermediate state of the hybrid bonus interactive wagering process based on the achievement of the base objective;
communicate the interactive intermediate state to the process controller;
receive an additional objective from the process controller; and
update the interactive user interface based on the additional objective; and
the process controller operatively connected to the interactive controller,
wherein the process controller includes a random number generator, and
wherein the process controller is constructed to:
receive the interactive intermediate state from the interactive controller;
generate a chance-based outcome using the random number generator in response to receiving the interactive intermediate state; and
in a case the chance-based outcome is not a win for the player, generate the additional objective and communicate the additional objective to the interactive controller.

2. The electronic gaming machine for performing the hybrid bonus interactive wagering process of claim 1, wherein the interactive controller and the process controller are constructed from the same device.

3. The electronic gaming machine for performing the hybrid bonus interactive wagering process of claim 1, wherein the process controller is operatively connected to the interactive controller using a communication link.

4. The electronic gaming machine for performing the hybrid bonus interactive wagering process of claim 1, further comprising:
an enclosure constructed to mount:
a user input device operatively connected to the interactive controller;
a user output device operatively connected to the interactive controller;
a credit input device operatively connected to the credit processing subcontroller; and
a credit output device operatively connected to the credit processing subcontroller,
wherein the process controller is further constructed to:
communicate with the credit input device to receive a credit input;
credit a credit meter with credits based on the incoming credit data; and
in a case the chance-based outcome is a win for the player:
determine a wagering outcome of the hybrid bonus interactive wagering process using the chance-based outcome;
update the credit meter based on the wagering outcome; and
communicate with the credit output device to generate a credit output based on credits transferred off of the credit meter.

5. An electronic gaming machine for performing a hybrid bonus interactive wagering process, comprising:
a random number generator;
at least one processor; and
a memory operatively connected to the at least one processor, the memory storing processor executable instructions that when executed by the processor cause the processor to:
generate an interactive user interface including interactive elements;
detect player interactions of a player with the interactive elements of the interactive user interface to determine achievement of a base objective;
determine an interactive intermediate state of the hybrid bonus interactive wagering process based on the achievement of the base objective;
generate a chance-based outcome using the random number generator in response to determining the interactive intermediate state; and
in a case the chance-based outcome is not a win for the player, generate an additional objective and update the interactive user interface based on the additional objective.

6. The electronic gaming machine for performing the hybrid bonus interactive wagering process of claim 5, further comprising:
an enclosure constructed to mount:
a user input device operatively connected to the at least one processor;
a user output device operatively connected to the at least one processor;
a credit input device operatively connected to the at least one processor; and
a credit output device operatively connected to the at least one processor,
wherein the executable instructions when executed by the at least one processor further cause the at least one processor to:
communicate with the credit input device to receive a credit input;
credit a credit meter with credits based on the incoming credit data; and
in a case the chance-based outcome is a win for the player:
determine a wagering outcome of the hybrid bonus interactive wagering process using the chance-based outcome;
update the credit meter based on the wagering outcome; and
communicate with the credit output device to generate a credit output based on credits transferred off of the credit meter.
